(19) United States
(12) Patent Application Publication
(10) Pub. No.: US 2026/0126899 A1
(43) Pub. Date: May 7, 2026

(54) METHOD FOR PROVIDING IMAGE, AND ELECTRONIC DEVICE SUPPORTING SAME

(71) Applicant: SAMSUNG ELECTRONICS CO., LTD., Suwon-si (KR)

(72) Inventors: Jiyoun HAN, Suwon-si (KR); Seunghee HWANG, Suwon-si (KR)

(73) Assignee: SAMSUNG ELECTRONICS CO., LTD., Suwon-si (KR)

(21) Appl. No.: 19/436,681

(22) Filed: Dec. 30, 2025

Related U.S. Application Data
(63) Continuation of application No. PCT/KR2024/009191, filed on Jul. 1, 2024.

(30) Foreign Application Priority Data
Jun. 30, 2023 (KR) 10-2023-0084728
Sep. 6, 2023 (KR) 10-2023-0118622
Mar. 22, 2024 (KR) 10-2024-0039581
Jun. 28, 2024 (KR) 10-2024-0085708

(51) Int. Cl. G06F 3/04845; G06F 3/0482; G06F 3/04847; G06F 3/0488

(52) U.S. Cl. CPC G06F 3/04845; G06F 3/0482; G06F 3/04847; G06F 3/0488

(57) ABSTRACT

An electronic device includes a memory and at least one processor. The at least one processor is configured to obtain a first image, to select one or more second images from among a plurality of images stored in the memory, based on at least one of a generation time of the first image and a generation location of the first image, which are included in metadata of the first image, to obtain a third image by changing a value of at least one attribute from among values of a plurality of attributes of the first image based on a user input, and to obtain one or more fourth images by changing values of a plurality of attributes of each of the one or more second images based on values of a plurality of attributes of the third image.

### CROSS-REFERENCE TO RELATED APPLICATIONS

This application is a continuation of International Application No. PCT/KR2024/009191, filed on Jul. 1, 2024, which is based on and claims priority to Korean Patent Application Nos. 10-2023-0084728, filed on Jun. 30, 2023, 10-2023-0118622, filed on Sep. 6, 2023, 10-2024-0039581, filed on Mar. 22, 2023, and 10-2024-0085708, filed on Jun. 28, 2024 in the Korean Patent Office, the disclosures of which are incorporated by reference herein in their entireties.

### BACKGROUND

### 1. Field

The disclosure relates to a method for providing an image and an electronic device supporting the method.

### 2. Description of Related Art

An electronic device such as a smartphone provides a function of editing an image. For example, the electronic device may obtain an image through a camera or obtain an image from memory (or an external electronic device). The electronic device may edit (e.g., correct) the obtained image by changing an attribute of the obtained image based on a user input, using an image editing program. For example, the electronic device may provide a filter function capable of changing an attribute of an image with respect to the image (e.g., an original image). The electronic device may display thumbnail images representing a plurality of filters capable of changing an attribute of an image (e.g., capable of providing a filter function), when the image is displayed. The electronic device may edit the image by applying a filter corresponding to the selected thumbnail image to the displayed image, when one thumbnail image is selected from among the thumbnail images based on a user input.

The above-described information may be provided as related art for the purpose of helping understanding of the disclosure. No claim or determination is made as to whether any of the foregoing is applicable as background art in relation to the disclosure.

### SUMMARY

The electronic device is performing an editing operation for each of a plurality of images, in order to edit the plurality of images. For example, the electronic device is individually performing an editing operation for an image 1 and an editing operation for an image 2, in order to edit the image 1 and the image 2.

When an image preferred by a user is present, the user may want to apply an attribute of the image to other images (e.g., a plurality of images similar to the image) at once. Alternatively, the user may want to correct one image and then apply an attribute of the corrected image to other images at once. Accordingly, the electronic device may need to provide a function capable of applying an attribute of an image preferred by a user or an attribute of an image corrected by a user to other images at once.

The disclosure relates to a method for providing an image, capable of applying an attribute of an image (e.g., an image selected by a user input) to other images at once, and an electronic device supporting the same.

The objects of the disclosure are not limited to the foregoing, and other objects not mentioned will be apparent to those of ordinary skill in the art to which the disclosure pertains from the following descriptions.

In an embodiment, an electronic device may include memory storing instructions and at least one processor operably coupled to the memory. The instructions, when executed by at least one processor individually or collectively, may cause the electronic device to obtain a first image. The instructions, when executed by at least one processor individually or collectively, may cause the electronic device to select one or more second images from among a plurality of images stored in the memory based on at least one of a generation time of the first image or a generation location of the first image in metadata of the first image. The instructions, when executed by at least one processor individually or collectively, may cause the electronic device to obtain a third image by changing a value of at least one attribute among values of a plurality of attributes of the first image based on a user input. The instructions, when executed by at least one processor individually or collectively, may cause the electronic device to obtain one or more fourth images by changing values of a plurality of attributes of each of the one or more second images based on the values of the plurality of attributes of the third image.

In an embodiment, a method for providing an image in an electronic device may include an operation of obtaining a first image. The method may include an operation of selecting one or more second images from among the plurality of images stored in the memory of the electronic device based on at least one of a generation time of the first image or a generation location of the first image in metadata of the first image. The method may include an operation of obtaining a third image by changing a value of at least one attribute among values of a plurality of attributes of the first image based on the user input. The method may include an operation of obtaining one or more fourth images by changing values of a plurality of attributes of each of the one or more second images based on the values of the plurality of attributes of the third image.

In an embodiment, an electronic device may include a camera, a display, memory, and at least one processor. The at least one processor may be configured to identify whether a condition for storing a second image to be obtained through the camera in a raw file format is satisfied, based on a first image obtained through the camera. The at least one processor may be configured to display guide information for storing the second image in the raw file format upon obtaining the second image through the display, based on identifying that the condition is satisfied. The at least one processor may be configured to store the second image in the raw file format in the memory based on obtaining the second image through the camera after displaying the guide information.

In an embodiment, in a non-transitory computer-readable medium storing computer-executable instructions, the computer-executable instructions may, when executed by at least one processor, cause an electronic device to obtain a first image. The computer-executable instructions may, when executed by at least one processor, cause the electronic device to select one or more second images from among a plurality of images stored in the memory based on at least one of a generation time of the first image or a generation location of the first image in metadata of the first image. The computer-executable instructions may, when executed by at least one processor, cause the electronic device to obtain a third image by changing a value of at least one attribute among values of a plurality of attributes of the first image based on a user input. The computer-executable instructions may, when executed by at least one processor, cause the electronic device to obtain one or more fourth images by changing values of a plurality of attributes of each of the one or more second images based on the values of the plurality of attributes of the third image.

### BRIEF DESCRIPTION OF DRAWINGS

FIG. 1 is a block diagram illustrating an electronic device in a network environment according to an embodiment.

FIG. 2 is a block diagram illustrating an electronic device, according to an embodiment.

FIG. 3 is a flowchart illustrating a method for providing an image, according to an embodiment.

FIGS. 4A and 4B are views illustrating a method for providing an image, according to an embodiment.

FIGS. 5A and 5B are views illustrating a method for providing an image, according to an embodiment.

FIG. 6 is a flowchart illustrating a method for providing an image, according to an embodiment.

FIG. 7 is a view illustrating a method for providing an image, according to an embodiment.

FIG. 8 is a flowchart illustrating a method for providing an image, according to an embodiment.

FIG. 9 is a view illustrating a method for providing an image, according to an embodiment.

FIG. 10 is a flowchart illustrating a method for providing an image, according to an embodiment.

FIG. 11 is a view illustrating a method for providing an image, according to an embodiment.

FIG. 12 is a view illustrating a method for storing an image, according to an embodiment.

FIG. 13 is a flowchart illustrating a method for providing an image, according to an embodiment.

FIG. 14 is a view illustrating a method for correcting an image stored in a raw file format, according to an embodiment.

FIGS. 15A and 15B are views illustrating a method for correcting an image stored in a raw file format, according to an embodiment.

FIG. 16 is a flowchart illustrating a method for providing an image, according to an embodiment.

FIGS. 17A and 17B are views illustrating a method for providing an image, according to an embodiment.

FIGS. 18A, 18B, and 18C are views illustrating a method for providing an image, according to an embodiment.

FIGS. 19A and 19B are views illustrating a method for providing an image, according to an embodiment.

FIGS. 20A, 20B, 20C, 20D, and 20E are views illustrating a method for providing an image, according to an embodiment.

FIGS. 21A, 21B, and 21C are views illustrating a method for providing an image, according to an embodiment.

FIGS. 22A, 22B, and 22C are views illustrating a method for generating and displaying a caption for a plurality of images selected based on an image collection view function, according to an embodiment.

FIGS. 23A and 23B are views illustrating a method for providing an image, according to an embodiment.

FIG. 24 is a view illustrating a method for providing an image, according to an embodiment.

FIG. 25 is a view illustrating a method for providing an image, according to an embodiment.

FIG. 26 is a view illustrating a method for changing a caption and registering a person, according to an embodiment.

FIG. 27 is a view illustrating a method for displaying a caption describing an image, according to an embodiment.

FIGS. 28A, 28B, and 28C are views illustrating a method for displaying a caption describing an image, according to an embodiment.

FIG. 29 is a view illustrating a method for providing an image summary keyword for a screenshot image, according to an embodiment.

FIG. 30 is a view illustrating a method for analyzing images and generating an image summary keyword using technologies such as visual question answering (VQA) and optical character recognition (OCR), according to an embodiment.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

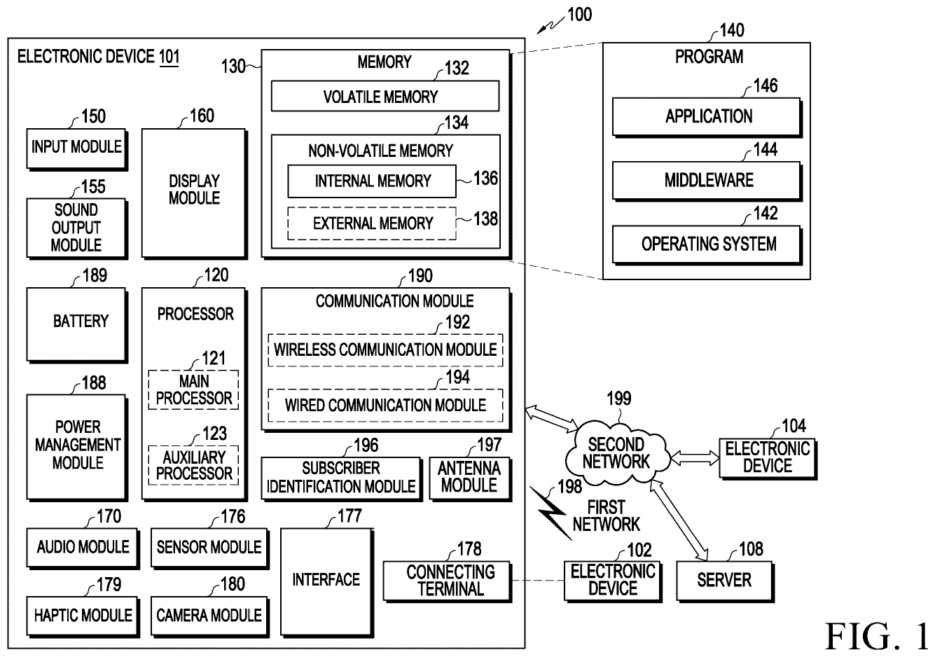

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. In connection to the description of the drawings, similar reference numerals may be used for similar or related components. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

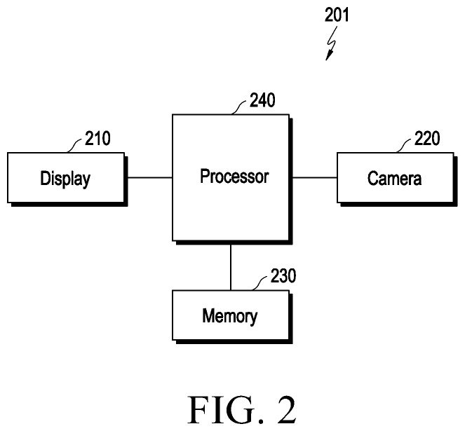

FIG. 2 is a block diagram illustrating an electronic device 201 according to an embodiment.

Referring to FIG. 2, the electronic device 201 may be the electronic device 101 of FIG. 1.

In an embodiment, the electronic device 201 may include a display 210, a camera 220, memory 230, and/or a processor 240.

In an embodiment, the display 210 may be included in the display module 160 of FIG. 1.

In an embodiment, the display 210 may display a screen including an image (e.g., a still image and/or a moving image). For example, the display 210 may display an execution screen of a camera application (e.g., a screen including a preview image obtained through the camera 220), based on the camera application being executed. For example, the display 210 may display an execution screen of an image application or an execution screen of an application for image editing, based on an image application (e.g., a gallery application) or an application for image editing (e.g., a photo editor) being executed.

In an embodiment, the camera 220 may be included in the camera module 180 of FIG. 1.

In an embodiment, the camera 220 may obtain an image (e.g., a still image or a moving image) based on a value set for image acquisition (e.g., image capture) (hereinafter, also referred to as a “camera setting value”).

In an embodiment, the camera setting value may include an exposure value (EV), a shutter speed, an International Organization for Standardization (ISO) value (also referred to as “ISO sensitivity”), a white balance (WB) (also referred to as “color temperature”), and/or focus information.

In an embodiment, the camera setting value may be set or adjusted based on a user input. For example, the camera setting value may be set by default. The camera setting value set by default may be adjusted based on a user input.

In an embodiment, the camera setting value may be set or adjusted based on an image obtained through the camera 220. For example, at least a portion of the camera setting value (e.g., an ISO value, a shutter speed) may be set or adjusted based on a capture environment (e.g., ambient brightness of the camera 220, an amount of light sensed by the camera 220) analyzed based on a preview image obtained through the camera 220.

In an embodiment, the memory 230 may be included in the memory 130 of FIG. 1.

In an embodiment, the memory 230 may store an image. For example, the memory 230 may store an image obtained through the camera 220. For example, the memory 230 may store a corrected image, when an image stored in the memory 230 is corrected. For example, the memory 230 may store an image received from an external electronic device (e.g., the electronic device 102 or the electronic device 104) through a communication circuit (e.g., the communication module 190 of FIG. 1).

In an embodiment, the memory 230 may store information for performing an operation of providing an image. The information stored by the memory 230 for performing an operation of providing an image is described in detail later.

According to an embodiment, the processor 240 may be included in the processor 120 of FIG. 1.

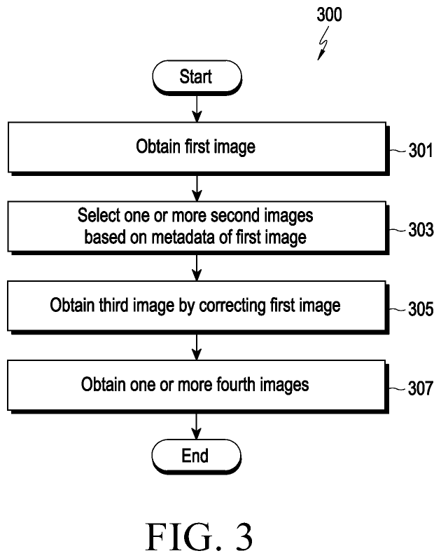

In an embodiment, the processor 240 may control an overall operation of providing an image. The processor 240 may include one or more processors for performing an operation of providing an image. The operation of providing an image performed by the processor 240 is described in detail with reference to the drawings from FIG. 3 onward.

Although FIG. 2 illustrates that the electronic device 201 includes the display 210, the camera 220, the memory 230, and/or the processor 240, the disclosure is not limited thereto. For example, the electronic device 201 may further include at least one component (e.g., the communication module 190) among the components included in the electronic device 101 of FIG. 1.

FIG. 3 is a flowchart 300 describing a method for providing an image, according to an embodiment.

Referring to FIG. 3, in operation 301, the processor 240 may obtain a first image.

In an embodiment, the first image may be an image serving as a reference for correcting one or more images (hereinafter, referred to as a “first image”). For example, the first image may be an image having a value of an attribute for correcting one or more images.

In an embodiment, the processor 240 may obtain the first image based on a user input for selecting the first image from among a plurality of images stored in the memory 230. For example, the processor 240 may display a plurality of images stored in the memory 230 through the display 210, based on execution of an image application (e.g., a gallery application). The processor 240 may obtain the first image by selecting the first image from among the plurality of images based on a user input. However, the operation of obtaining the first image is not limited to the above-described example. For example, the processor 240 may obtain an image (e.g., a capture image) through the camera 220. The processor 240 may obtain the first image by determining the image obtained through the camera 220 as the first image serving as a reference for correcting one or more images.

In operation 303, the processor 240 may select one or more second images from among a plurality of images stored in the memory 230 based on metadata of the first image.

In an embodiment, the one or more second images may be one or more images that are subjects of correction based on the first image (hereinafter, referred to as “one or more second images”). For example, the one or more second images may be one or more images to be corrected based on the first image (e.g., an attribute value of the first image).

In an embodiment, the metadata of an image (e.g., the first image) may include a unique identifier (ID) of the image, a name of the image, a generation time of the image, a generation location of the image, and/or information about editing (or correction) of the image (e.g., an identifier of a filter when a filter is applied to the image, an attribute value of the filter). However, the information included in the metadata of the image is not limited to the above-described examples.

In an embodiment, the metadata of an image (e.g., the first image) may be combined with data of the image (or image data) to be generated as one file, or may be generated as a file separate from the image data, and stored in the memory 230.

In an embodiment, the processor 240 may select one or more second images from among a plurality of images stored in the memory 230 based on the generation time of the first image and/or the generation location of the first image included in the metadata of the first image.

In an embodiment, the generation time of the first image included in the metadata of the first image may include a date and time when the first image is captured (e.g., 10:35 AM on Feb. 14, 2024).

In an embodiment, the processor 240 may select one or more second images obtained (e.g., captured through the camera 220) within a designated time range (hereinafter, also referred to as a “designated time range”) based on the generation time of the first image (e.g., the generation date and generation time of the first image) included in the metadata of the first image, from among a plurality of images stored in the memory 230. For example, the processor 240 may identify generation times of each of the plurality of images included in the metadata of the plurality of images stored in the memory 230. The processor 240 may select, as the one or more second images, images that are created (e.g., captured) at a time belonging to a time range from the generation time of the first image to a time that is a designated time (e.g., about 5 minutes) before the generation time of the first image and/or a time range from the generation time of the first image to a time that is a designated time after the generation time of the first image, based on the generation times of each of the plurality of images, from among the plurality of images.

In an embodiment, the designated time range may be a time range designated by default. In an embodiment, the processor 240 may designate a time range for selecting one or more second images based on the generation time of the first image included in the metadata of the first image, based on a user input.

In an embodiment, the generation location of the first image included in the metadata of the first image may include information about a location where the first image is captured. For example, the generation location of the first image may include a latitude and longitude of a location where the first image is captured, an address of a location where the first image is captured, and/or a place where the first image is captured.

In an embodiment, the processor 240 may select one or more second images obtained (e.g., captured through the camera 220) within a designated distance (e.g., radius) (hereinafter, also referred to as a “designated distance”) based on the generation location of the first image included in the metadata of the first image, from among a plurality of images stored in the memory 230. For example, the processor 240 may identify generation locations of each of the plurality of images included in the metadata of the plurality of images stored in the memory 230. The processor 240 may select, as the one or more second images, images that are created (e.g., captured) at a location within a designated radius from the generation location of the first image, based on the generation locations of each of the plurality of images, from among the plurality of images.

In an embodiment, the designated distance may be a distance designated by default based on a user input. In an embodiment, the processor 240 may designate a distance for selecting one or more second images based on the generation location of the first image included in the metadata of the first image, based on a user input.

In an embodiment, the processor 240 may select one or more second images that are obtained (e.g., captured) within a designated time range based on the generation location of the first image included in the metadata of the first image and that are obtained within a designated distance based on the generation location of the first image included in the metadata of the first image, from among a plurality of images stored in the memory 230.

In the above-described examples, although it is described that one or more second images are selected from among a plurality of images stored in the memory 230 based on the metadata of the first image (e.g., the generation time and/or generation location of the first image), the disclosure is not limited thereto.

In an embodiment, the processor 240 may select one or more second images from among a plurality of images stored in the memory 230 based on an object included in the first image. For example, the processor 240 may detect information about an object included in the first image (e.g., a type of the object and/or a subject represented by the object) using an object detection algorithm or a designated artificial intelligence model. The processor 240 may select, as the one or more second images, images including an object corresponding to the same subject as a subject (e.g., a person, an animal, an object) corresponding to (e.g., represented by) the object included in the first image, from among a plurality of images stored in the memory 230.

In an embodiment, the processor 240 may select one or more second images from among a plurality of images stored in the memory 230 based on the generation time of the first image and/or the generation location of the first image included in the metadata of the first image, and the object included in the first image.

In operation 305, the processor 240 may obtain a third image by correcting the first image based on a user input.

In an embodiment, the third image may be an image obtained or generated by changing at least one attribute value among values of a plurality of attributes of the first image (hereinafter, referred to as a “third image”). For example, the third image may be an image having a plurality of attribute values in which at least a portion of the plurality of attribute values of the first image is changed.

In an embodiment, the plurality of attributes of an image (e.g., the first image) may include exposure, brightness, contrast (also referred to as “contrast ratio”), highlight, shadow, chroma, color temperature, tint, sharpness, and/or clarity. However, the plurality of attributes of the image is not limited to the above-described examples.

In an embodiment, the values of the plurality of attributes of an image (e.g., the first image) may be values for representing or indicating degrees (e.g., levels) of the plurality of attributes of the image.

In an embodiment, the processor 240 may display an object (e.g., a graphic object) (or a user interface) for setting or adjusting a plurality of attribute values of the first image through the display 210, based on the first image being obtained. In an embodiment, the processor 240 may adjust a plurality of attribute values of the first image based on a user input for an object for setting the plurality of attribute values of the first image. For example, the processor 240 may adjust a plurality of attribute values (e.g., intensities corresponding to the plurality of attribute values of the first image) of the first image based on a user input for an object for setting the plurality of attribute values of the first image. The processor 240 may obtain a third image by adjusting the plurality of attribute values of the first image. However, the operation of obtaining a third image by changing at least one attribute value among a plurality of attribute values of the first image is not limited to the above-described examples. For example, the processor 240 may obtain a third image by applying a filter (e.g., a filter capable of applying a designated visual effect or a designated style to an image) to the first image.

In FIG. 3, operation 303 is an example as being performed prior to operation 305, but is not limited thereto. For example, the processor 240 may perform operation 303 after performing operation 305.

In operation 307, the processor 240 may obtain one or more fourth images by correcting one or more second images based on the third image.

In an embodiment, the processor 240 may obtain one or more fourth images by changing or adjusting values of a plurality of attributes of each of the one or more second images based on the values of the plurality of attributes of the third image. For example, the processor 240 may change a plurality of attribute values of the one or more second images such that the one or more second images may be changed to one or more fourth images having a plurality of attribute values identical to the values of the plurality of attributes of the third image. However, the disclosure is not limited thereto. For example, the processor 240 may change a plurality of attribute values of the one or more second images such that the one or more second images may be changed to one or more fourth images having attribute values identical to a portion of the values of the plurality of attributes of the third image. For example, the processor 240 may change a plurality of attribute values of the one or more second images such that the one or more second images may be changed to one or more fourth images having attribute values identical to attribute values adjusted based on a user input among the values of the plurality of attributes of the third image.

In an embodiment, the one or more fourth images may be images (hereinafter, referred to as “one or more fourth images”) obtained or generated by applying the values of the plurality of attributes of the third image to each of the one or more second images (e.g., attributes of the one or more second images). For example, when the one or more second images include the image 1 and the image 2, the processor 240 may obtain the image 3 by applying the values of the plurality of attributes of the third image to the image 1, and may obtain the image 4 by applying the values of the plurality of attributes of the third image to the image 2. For example, the image 3 and the image 4 may be included in the one or more fourth images.

In an embodiment, the processor 240 may obtain one or more fourth images by correcting one or more second images at once based on the third image. For example, the processor 240 may obtain one or more fourth images by sequentially correcting one or more second images based on the third image. For example, the processor 240 may obtain one or more fourth images by performing operations of correcting each of the one or more second images based on the third image in parallel. For example, the processor 240 may obtain one or more fourth images by correcting one or more second images based on the third image without an additional user input.

In the above-described examples, although it is described that one or more second images are corrected based on the third image obtained by correcting the first image, the disclosure is not limited thereto. In an embodiment, the processor 240 may obtain one or more fourth images by correcting one or more second images based on the first image, when a user input for correcting the first image is not obtained after the first image is obtained in operation 301. For example, the processor 240 may obtain one or more fourth images by applying the values of the plurality of attributes of the first image to the one or more second images, when a user input for correcting the first image is not obtained after the first image is obtained (e.g., when a user does not want to modify the first image).

In an embodiment, the processor 240 may obtain one or more fourth images in addition to the one or more second images. For example, the processor 240 may store one or more fourth images in the memory 230, without deleting the one or more second images from the memory 230, based on obtaining one or more fourth images based on the one or more second images. However, the disclosure is not limited thereto. For example, the processor 240 may store information for restoring one or more second images from one or more fourth images and the one or more fourth images in the memory 230, and may delete the one or more second images from the memory 230, based on obtaining the one or more fourth images. For example, the processor 240 may store one or more fourth images in the memory 230, and may store one or more second images in the memory 230 without storing information for restoring one or more second images from the one or more fourth images in the memory 230, based on obtaining the one or more fourth images.

In an embodiment, the processor 240 may display one or more fourth images through the display 210. For example, the processor 240 may display an execution screen of a gallery application including thumbnail images corresponding to one or more fourth images through the display 210.

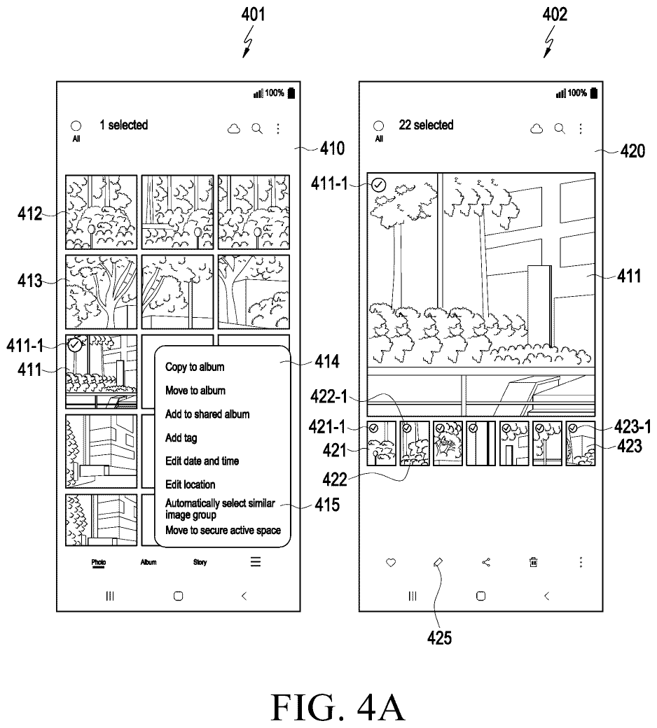

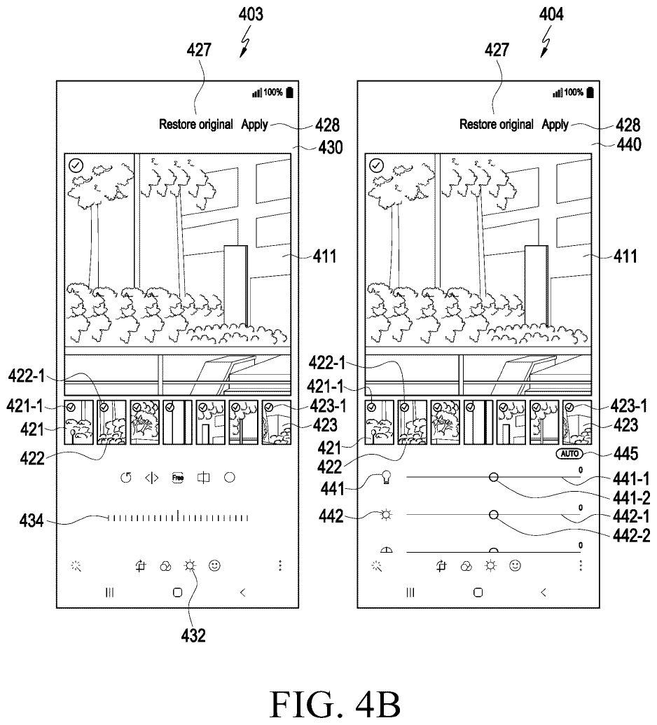

FIGS. 4A and 4B are views illustrating a method for providing an image, according to an embodiment.

Referring to FIGS. 4A and 4B, at reference numeral 401, the processor 240 may display a screen 410 including a plurality of images (e.g., the images 411, 412, and 413) stored in the memory 230 through the display 210, based on a gallery application being executed. For example, the processor 240 may display a plurality of images (e.g., the images 411, 412, and 413) stored in the memory 230 in a thumbnail form through the display 210, based on a gallery application being executed. The processor 240 may select a first image 411 from among the plurality of images (e.g., the images 411, 412, and 413) based on a user input, when the plurality of images (e.g., the images 411, 412, and 413) are displayed. The processor 240 may display an object 411-1 indicating that the first image 411 is selected within the first image 411 through the display 210, when the first image 411 is selected from among the plurality of images (e.g., the images 411, 412, and 413).

In an embodiment, the processor 240 may display an object (or a menu) for selecting one or more second images from among a plurality of images stored in the memory 230 based on the metadata of the first image (e.g., the generation time of the first image and/or the generation location of the first image included in the metadata of the first image) (and/or an object included in the first image) through the display 210, when the first image 411 is selected (or based on a user input after the first image 411 is selected). For example, at reference numeral 401, the processor 240 may display a window 414 including objects corresponding to functions related to the first image 411 through the display 210, when the first image 411 is selected. The processor 240 may perform an operation of selecting one or more second images from among a plurality of images stored in the memory 230 based on the metadata of the first image, based on a user input selecting an object 415 for selecting one or more second images from among a plurality of images stored in the memory 230, from among the objects included in the window 414.

In an embodiment, at reference numeral 402, the processor 240 may display a screen 420 including the first image 411 and one or more second images (e.g., the images 421, 422, and 423) displayed in a thumbnail form through the display 210, when the one or more second images (e.g., the images 421, 422, and 423) is selected.

In an embodiment, the processor 240 may display objects (e.g., the objects 421-1, 422-1, and 423-1) indicating that the one or more second images (e.g., the images 421, 422, and 423) are selected as subjects of correction based on the first image 411 within the one or more second images (e.g., the images 421, 422, and 423) through the display 210.

In an embodiment, the processor 240 may deselect at least a portion of the one or more second images (e.g., the images 421, 422, and 423) based on a user input for at least a portion of the one or more second images (e.g., the images 421, 422, and 423), after the one or more second images (e.g., the images 421, 422, and 423) are selected. For example, the processor 240 may deselect the image 421 (e.g., exclude the image 421 from subjects to be corrected based on the first image 411) based on a user input for the image 421, after the image 421 is selected. The processor 240 may control the display 210 such that the object 421-1 may disappear from within the image 421, when selection of the image 421 is deselected.

In an embodiment, at reference numerals 402 and 403, the processor 240 may display a screen 430 including objects (e.g., an object 432) for editing the first image 411 together with the first image 411 and one or more second images (e.g., the images 421, 422, and 423) displayed in a thumbnail form through the display 210, based on a user input for an object 425 (e.g., an icon) for editing the first image 411.

In an embodiment, at reference numerals 403 and 404, the processor 240 may display a screen 440 including objects (or a user interface) for adjusting values of a plurality of attributes of the first image 411 together with the first image 411 and one or more second images (e.g., the images 421, 422, and 423) displayed in a thumbnail form through the display 210, based on a user input for an object 432 for correcting the first image 411. For example, in order to adjust exposure of the first image 411, the processor 240 may display an object 441 representing exposure, a bar-shaped object 441-1, and an object 441-2 (also referred to as a “slider”) movable on the object 441-1 based on a user input through the display 210. For example, in order to adjust brightness of the first image 411, the processor 240 may display an object 442 representing brightness, a bar-shaped object 442-1, and an object 442-2 movable on the object 441-1 based on a user input through the display 210.

In an embodiment, the processor 240 may adjust a value of an attribute of the first image 411 based on a user input. In an embodiment, the processor 240 may adjust the value of the exposure (e.g., intensity of the exposure) of the first image 411 by moving a position of the object 441-2 on the object 441-1 based on a user input. For example, the processor 240 may increase the value of the exposure (e.g., an attribute representing brightness of an entire area of the first image 411) of the first image 411, based on a drag input for the object 441-2 for moving a position of the object 441-2 set by default on the object 441-1 (e.g., a center position of the object 441-1) in a right direction. For example, the processor 240 may decrease the value of the exposure of the first image 411, based on a drag input for the object 441-2 for moving a position of the object 441-2 set by default on the object 441-1 in a left direction. In an embodiment, the processor 240 may adjust the value of the brightness (e.g., an attribute representing brightness of an area having a brightness value equal to or less than a threshold brightness value in the first image 411) of the first image 411 by moving a position of the object 442-2 on the object 442-1 based on a user input.

In an embodiment, the processor 240 may adjust a value of at least a portion of the attributes among the values of the plurality of attributes of the first image 411 by analyzing the first image 411, based on a user input for an object 445. For example, the processor 240 may automatically adjust a value of at least a portion of the attributes among the values of the plurality of attributes of the first image 411 such that the first image 411 may have optimized attribute values, based on a user input for the object 445.

In an embodiment, the processor 240 may obtain a third image in which the first image 411 is corrected, based on a user input for an object 428, after correction for the first image 411 is performed. The processor 240 may obtain one or more fourth images by applying the values of the plurality of attributes of the third image to the one or more second images (e.g., the images 421, 422, and 423), based on a user input for the object 428, after correction for the first image 411 is performed.

In an embodiment, the processor 240 may restore the first image 411 based on a user input for an object 427, after correction for the first image 411 is performed or when correction for the first image 411 is performed. For example, the processor 240 may restore the first image 411 to an original image before correction by removing a correction effect applied to the first image 411, based on a user input for the object 427, after correction for the first image 411 is performed or when correction for the first image 411 is performed.

In an embodiment, the processor 240 may deselect at least a portion of the one or more second images (e.g., the images 421, 422, and 423) based on a user input for at least a portion of the one or more second images (e.g., the images 421, 422, and 423), before obtaining a user input for the object 428 after performing correction, at reference numeral 404. The processor 240 may perform an operation of applying the values of the plurality of attributes of the third image to at least one second image finally selected from among the one or more second images (e.g., the images 421, 422, and 423), based on a user input for the object 428 obtained after a portion of the one or more second images (e.g., the images 421, 422, and 423) is deselected.

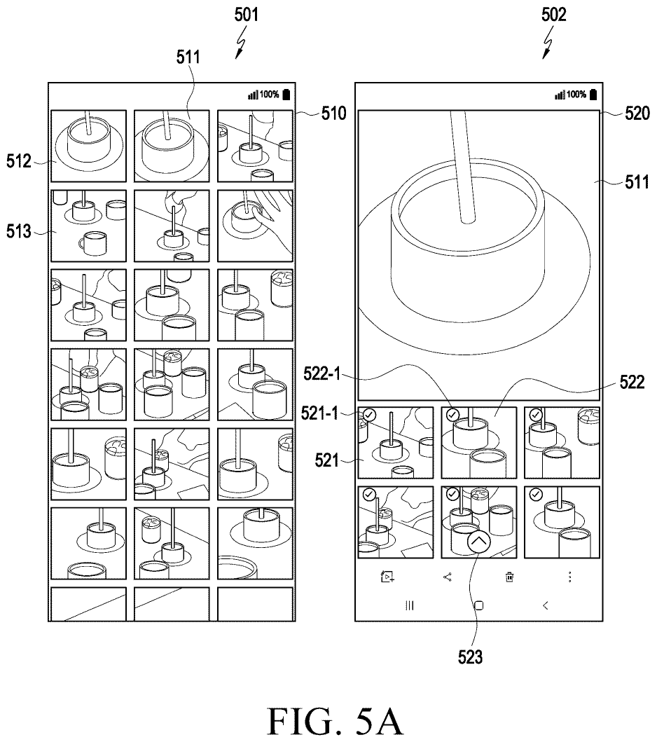

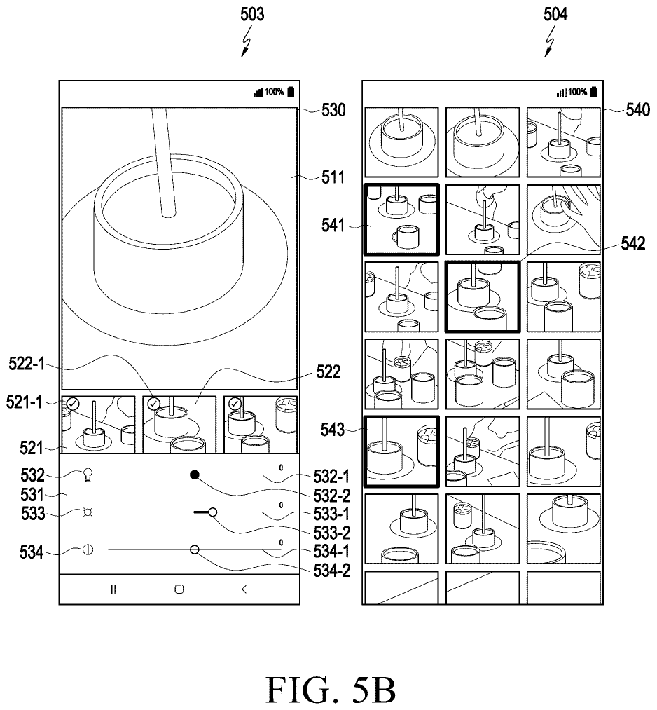

FIGS. 5A and 5B are views illustrating a method for providing an image, according to an embodiment.

Referring to FIGS. 5A and 5B, at reference numeral 501, the processor 240 may display a screen 510 including a plurality of images (e.g., the images 511, 512, and 513) stored in the memory 230 through the display 210, based on a gallery application being executed. For example, the processor 240 may display a plurality of images (e.g., the images 511, 512, and 513) stored in the memory 230 in a thumbnail form through the display 210, based on a gallery application being executed. The processor 240 may select a first image 511 from among the plurality of images (e.g., the images 511, 512, and 513) based on a user input, when the plurality of images (e.g., the images 511, 512, and 513) are displayed.

In an embodiment, at reference numeral 502, the processor 240 may select one or more second images (e.g., the images 521 and 522) based on the metadata of the first image (e.g., the generation time of the first image and/or the generation location of the first image included in the metadata of the first image) (and/or an object included in the first image), when the first image 511 is selected (or based on a user input after the first image 511 is selected). The processor 240 may display a screen 520 including the first image 511 and one or more second images (e.g., the images 521 and 522) displayed in a thumbnail form through the display 210, when the one or more second images (e.g., the images 521 and 522) is selected.

In an embodiment, the processor 240 may display objects (e.g., the objects 521-1, 522-1) indicating that the one or more second images (e.g., the images 521 and 522) are selected as subjects of correction based on the first image 511 within the one or more second images (e.g., the images 521 and 522) through the display 210. In an embodiment, the processor 240 may display an object 523 for scrolling an area in which the one or more second images (e.g., the images 521 and 522) are displayed through the display 210.

In an embodiment, at reference numeral 503, the processor 240 may display a user interface 531 including objects (or a user interface) for adjusting values of a plurality of attributes of the first image 511 together with the first image 511 and one or more second images (e.g., the images 521 and 522) displayed in a thumbnail form through the display 210, based on a user input for correcting the first image 511. For example, in order to adjust exposure of the first image 511, the processor 240 may display an object 532 representing exposure, a bar-shaped object 532-1, and an object 532-2 movable on the object 532-1 based on a user input through the display 210. For example, in order to adjust brightness of the first image 511, the processor 240 may display an object 533 representing brightness, a bar-shaped object 533-1, and an object 533-2 movable on the object 533-1 based on a user input through the display 210. For example, in order to adjust contrast of the first image 511, the processor 240 may display an object 534 representing contrast, a bar-shaped object 534-1, and an object 534-2 movable on the object 534-1 based on a user input through the display 210.

In an embodiment, the processor 240 may adjust a value of an attribute of the first image 511 based on a user input for the user interface 531 (e.g., a user input for the objects 532-2, 533-2, 534-2). The operation of adjusting an attribute value of the first image 511 based on a user input for the objects (e.g., the objects 441-2, 442-2) at reference numeral 404 of FIG. 4B is at least partially identical or similar to the operation of adjusting an attribute value of the first image 511 based on a user input for the user interface 531, so a detailed description thereof is omitted.

In an embodiment, the processor 240 may obtain a third image in which the first image 511 is corrected by performing correction for the first image 511, at reference numerals 503 and 504. The processor 240 may obtain one or more fourth images (e.g., the images 541, 542, 543) by applying a plurality of attribute values of the third image to the one or more second images (e.g., the images 521 and 522). The processor 240 may display the one or more fourth images (e.g., the images 541, 542, and 543) in a thumbnail form through the display 210, as illustrated at reference numeral 504, based on the one or more fourth images (e.g., the images 541, 542, 543) being obtained.

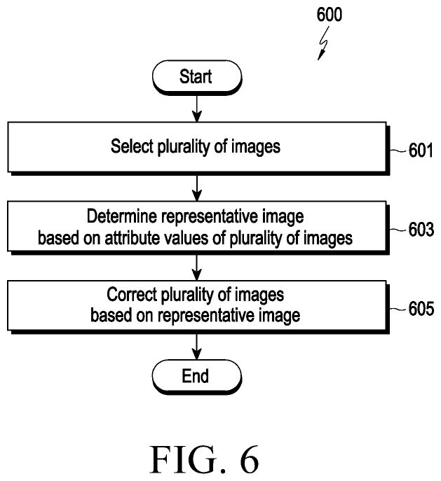

FIG. 6 is a flowchart 600 describing a method for providing an image, according to an embodiment.

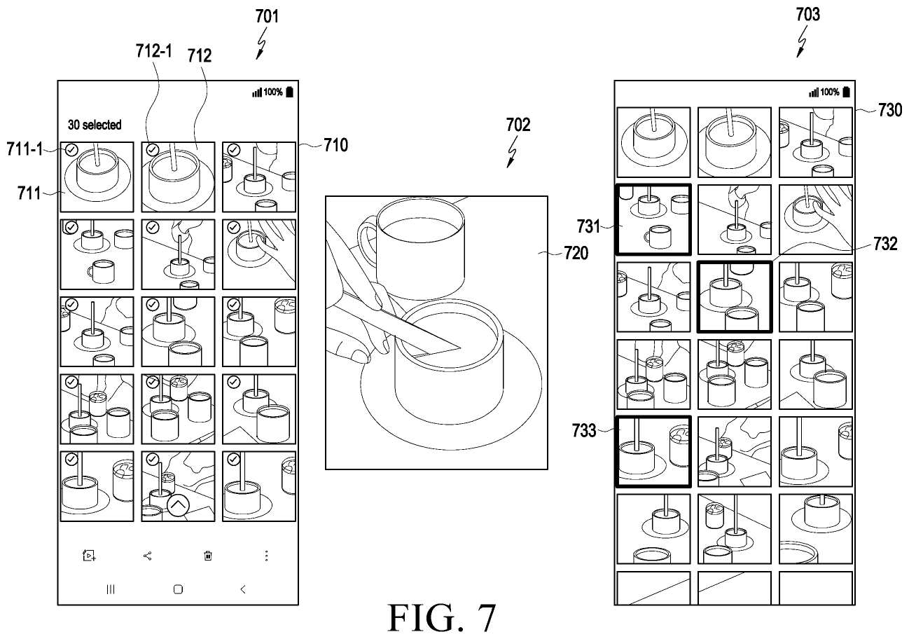

FIG. 7 is a view illustrating a method for providing an image, according to an embodiment.

Referring to FIGS. 6 and 7, in operation 601, the processor 240 may select a plurality of images based on a user input.

In an embodiment, the processor 240 may display images stored in the memory 230 through the display 210, based on execution of an image application (e.g., a gallery application). The processor 240 may select a plurality of images (hereinafter, referred to as “a plurality of images”) from among the images based on a user input. The processor 240 may display a screen 710 including a plurality of images (e.g., the images 711 and 712) selected based on a user input through the display 210, when a plurality of images is selected from among the images, as illustrated at reference numeral 701 of FIG. 7. The processor 240 may display objects (e.g., the objects 711-1 and 712-1) indicating that the plurality of images (e.g., the images 711 and 712) are selected together with the plurality of images (e.g., the images 711 and 712) within the plurality of images (e.g., the images 711 and 712) through the display 210.

In operation 603, the processor 240 may determine a representative image based on attribute values of the plurality of images.

In an embodiment, the processor 240 may determine the representative image from among the plurality of images based on attribute values (e.g., exposure, brightness, contrast, highlight, shadow, chroma, color temperature (e.g., white balance), tint, sharpness, and/or clarity) of the plurality of images (e.g., a plurality of images selected in operation 601).

In an embodiment, the processor 240 may analyze (e.g., extract) the values of the plurality of attributes of the plurality of images with respect to each of the plurality of attributes. The processor 240 may obtain (e.g., calculate) averages of the values of the plurality of attributes of the plurality of images with respect to each of the plurality of attributes. For example, the processor 240 may calculate an average of exposures of the plurality of images. For example, the processor 240 may calculate an average of brightnesses of the plurality of images.

In an embodiment, the processor 240 may determine an image having attribute values closest to the averages of the plurality of attribute values from among the plurality of images as the representative image, based on a difference between the plurality of attribute values of the plurality of images and the averages of the plurality of attribute values. For example, the processor 240 may calculate sums (or sums of squares) of differences between the plurality of attribute values and the averages of the plurality of attributes with respect to each of the plurality of images. The processor 240 may determine an image having a minimum value among sums of differences between the plurality of attribute values and the averages of the plurality of attributes as the representative image, from among the plurality of images. However, the method for determining the representative image is not limited to the above-described examples.

In an embodiment, the processor 240 may determine the representative image from among the plurality of images based on compositions of the plurality of images (e.g., a position of an object within each of the plurality of images and/or a direction toward which the object faces).

In an embodiment, the processor 240 may calculate, in each of the plurality of images, a position of an object included in the image (e.g., coordinates of the object within the image) and/or a horizontal angle of an object included in the image (e.g., an angle between a horizontal axis of the object and a horizontal axis of the image) and a vertical angle (e.g., an angle between a vertical axis of the object and a vertical axis of the image) (hereinafter, referred to as a “value of the composition of the image”).

In an embodiment, the processor 240 may calculate an average of positions of objects included in each of the plurality of images, an average of horizontal angles, and an average of vertical angles (hereinafter, referred to as an “average of compositions of the plurality of images”).

In an embodiment, the processor 240 may determine an image in which a difference between the value of the composition of the image and the average of the compositions of the plurality of images is minimized as the representative image, from among the plurality of images.

In an embodiment, the processor 240 may determine the representative image based on attribute values of the plurality of images and compositions of the plurality of images.

In an embodiment, reference numeral 702 may represent the representative image 720 determined from among the plurality of images (e.g., the images 711 and 712). For example, the representative image 720 may be an image in which an object (e.g., a cake) included in the representative image 720 is positioned at a center of the representative image 720, an entire area of the object is included in the representative image 720, and a horizontal angle and a vertical angle are substantially 0 degrees.

In operation 605, the processor 240 may correct the plurality of images based on the representative image.

In an embodiment, the processor 240 may correct the plurality of images by applying a plurality of attribute values of the representative image to the plurality of images (e.g., a plurality of images selected in operation 601).

In an embodiment, the processor 240 may select one or more images to which a plurality of attribute values of the representative image are to be applied, based on a user input, after the representative image is determined. The processor 240 may select one or more images to which a plurality of attribute values of the representative image are to be applied, based on a user input, after the representative image is determined based on attribute values of the plurality of images in operation 603.

In an embodiment, the processor 240 may select one or more images to which a plurality of attribute values of the representative image are to be applied, from among the plurality of images. However, the disclosure is not limited thereto, and the processor 240 may select one or more images to which a plurality of attribute values of the representative image are to be applied, from among images stored in the memory 230 other than the plurality of images.

In an embodiment, the processor 240 may display the plurality of corrected images through the display 210, based on the plurality of images being corrected. For example, the processor 240 may display a screen 730 including a plurality of corrected images 731, 732, and 733 through the display 210, as illustrated at reference numeral 703 of FIG. 7.

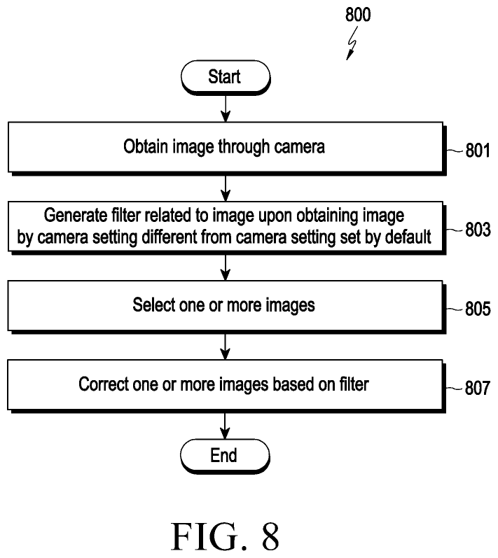

FIG. 8 is a flowchart 800 describing a method for providing an image, according to an embodiment.

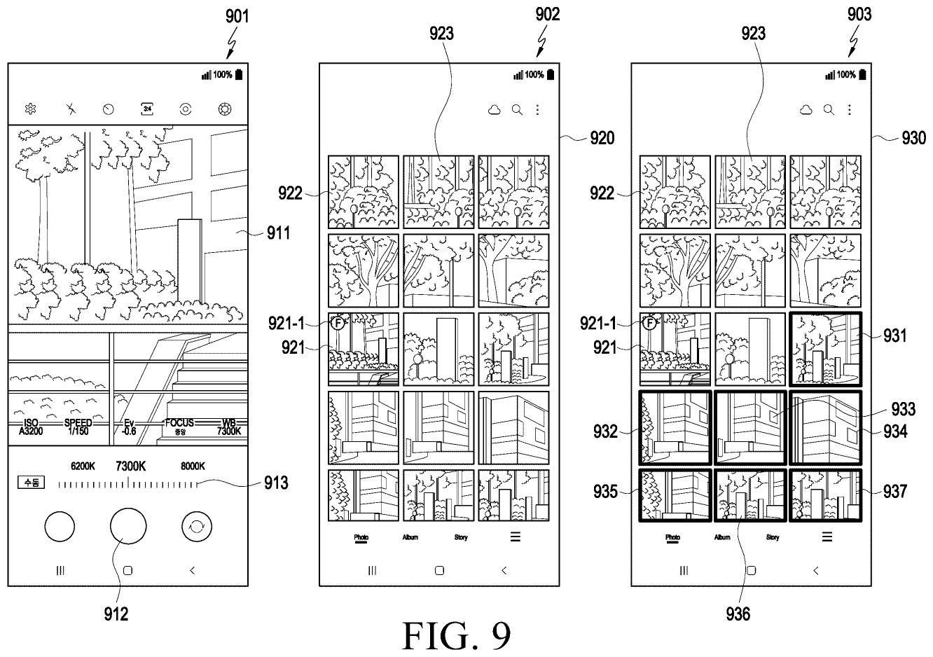

FIG. 9 is a view illustrating a method for providing an image, according to an embodiment.

Referring to FIGS. 8 and 9, in operation 801, the processor 240 may obtain an image through the camera 220. For example, the processor 240 may display a preview image through the display 210, based on images obtained through the camera 220. The processor 240 may obtain an image (e.g., a capture image) (hereinafter, referred to as a “first image”) based on a user input for capturing an image, when a preview image is displayed.

In an embodiment, the processor 240 may obtain a first image through the camera 220 based on a camera setting value.

In an embodiment, the camera setting value may include an exposure value (EV), a shutter speed, an International Organization for Standardization (ISO) value (also referred to as “ISO sensitivity”), a white balance (WB), and/or focus information.

In an embodiment, the processor 240 may obtain the first image through the camera 220 based on the camera setting value set by default.

In an embodiment, the processor 240 may obtain the first image through the camera 220 based on the camera setting value set based on a user input. For example, the processor 240 may adjust the camera setting value set by default based on a user input (hereinafter, the camera setting value adjusted from the camera setting value set by default based on a user input is referred to as a “first camera setting value”). The processor 240 may obtain the first image through the camera 220 based on the first camera setting value.

In an embodiment, at reference numeral 901 of FIG. 9, the processor 240 may display a screen 910 including a preview image 911, an object 913 for adjusting the camera setting value (e.g., color temperature), and an object 912 for capturing an image through the display 210. The processor 240 may adjust the camera setting value (e.g., color temperature) based on a user input for the object 913.

In an embodiment, the processor 240 may obtain the first image through the camera 220 based on the camera setting value set based on an image (e.g., a preview image) obtained through the camera 220. For example, at least a portion of the camera setting value (e.g., an ISO value, a shutter speed) may be adjusted based on a capture environment (e.g., ambient brightness of the camera 220, an amount of light sensed by the camera 220) analyzed based on a preview image obtained through the camera 220 (hereinafter, the camera setting value adjusted from the camera setting value set by default based on an image obtained through the camera 220 is referred to as a “second camera setting value”). The processor 240 may obtain the first image through the camera 220 based on the second camera setting value.

In operation 803, the processor 240 may generate a filter related to an image (e.g., the first image), upon obtaining the image (e.g., the first image) by a camera setting different from a camera setting set by default. For example, the processor 240 may generate a filter related to the first image, based on the first image being obtained based on the camera setting value different from the camera setting value set by default.

In an embodiment, the processor 240 may generate a filter related to the first image, upon obtaining the first image by the first camera setting value and/or the second camera setting value.

In an embodiment, the filter related to the first image may include a filter capable of applying the camera setting value of the first image (and/or at least a portion of a plurality of attribute values of the first image) to other one or more images.

In an embodiment, the processor 240 may store the filter related to the first image in the memory 230, based on the filter related to the first image being generated.

In an embodiment, the processor 240 may display an object indicating that the filter related to the first image is generated with respect to the first image through the display 210, upon displaying the first image. For example, at reference numeral 902 of FIG. 9, the processor 240 may display an object 921-1 indicating that the filter related to the first image 921 is generated within the first image 921 through the display 210, upon displaying a screen 920 including the first image 921 and other images (e.g., the images 922, 923) stored in the memory 230.

In operation 805, the processor 240 may select one or more images (hereinafter, referred to as “one or more second images”) from among a plurality of images stored in the memory 230.

In an embodiment, the processor 240 may select one or more second images from among the plurality of images stored in the memory 230, based on a user input.

In an embodiment, the processor 240 may select one or more second images from among the plurality of images stored in the memory 230, based on metadata of the first image. Since the operation of the processor 240 selecting one or more second images from among the plurality of images stored in the memory 230 based on metadata of the first image is at least partially identical or similar to the operation described through operation 303 of FIG. 3, a redundant description thereof is omitted.

In an embodiment, at reference numeral 903 of FIG. 9, the processor 240 may select one or more second images (e.g., the images 931, 932, 933, 934, 935, 936, and 937) within a screen 930 displayed through the display 210.

In operation 807, the processor 240 may correct one or more images (e.g., the one or more second images) based on the filter (e.g., the filter related to the first image).

In an embodiment, the processor 240 may apply the camera setting value of the first image (and/or at least a portion of a plurality of attribute values of the first image) to the one or more second images, using the filter related to the first image. For example, the processor 240 may correct the second image such that the second image may have a shutter speed of 1/180(s), an exposure value of +0.6, and a color temperature of 7300K, based on obtaining the first image 220 based on a first camera setting value set to a shutter speed of 1/180(s), an exposure value of +0.6, and a color temperature of 7300K, and then selecting a second image having a shutter speed of 1/60(s), an exposure value of +0.0, and a color temperature of 8000K. However, the method for applying the camera setting value of the first image (and/or at least a portion of a plurality of attribute values of the first image) to the one or more second images using the filter related to the first image is not limited to the above-described example.

In an embodiment, the processor 240 may apply the filter related to the first image to other at least one image, after the first image and the filter related to the first image are stored. For example, the processor 240 may display a plurality of images including the first image through the display 210, based on execution of a gallery application, after the first image and the filter related to the first image are stored. The processor 240 may apply the filter related to the first image to the selected at least one image by selecting at least one image to which the filter related to the first image is to be applied from among the plurality of images.

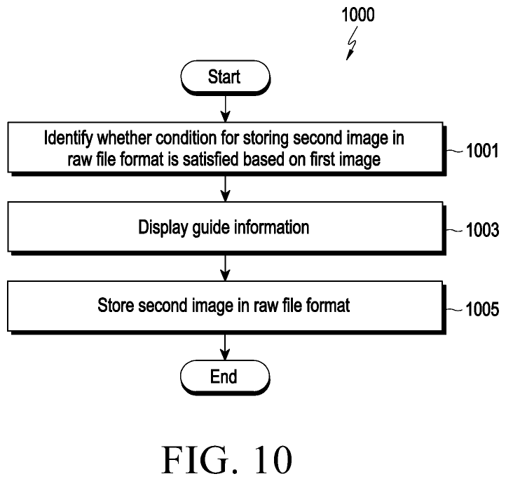

FIG. 10 is a flowchart 1000 describing a method for providing an image, according to an embodiment.

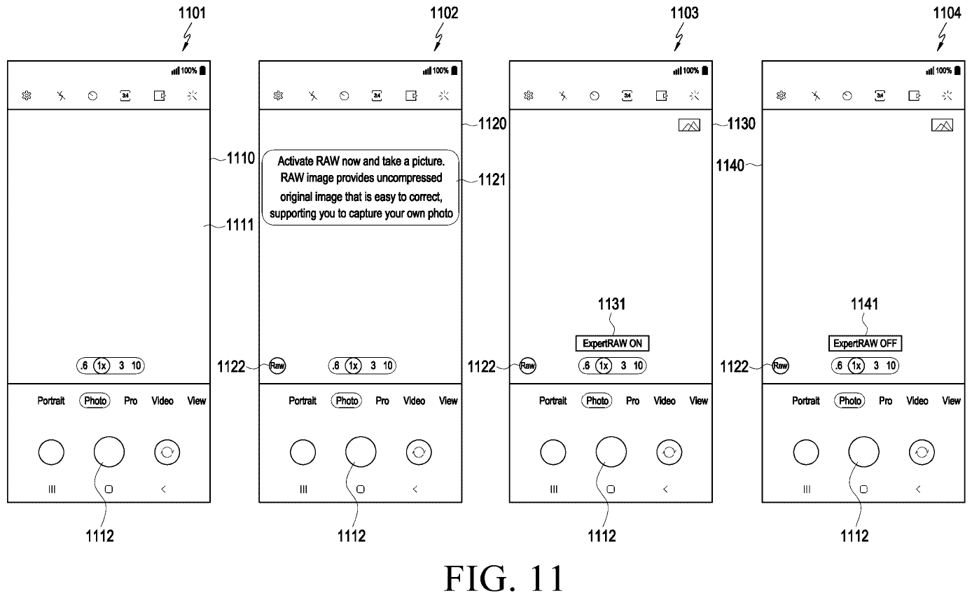

FIG. 11 is a view illustrating a method for providing an image, according to an embodiment.

Referring to FIGS. 10 and 11, in operation 1001, the processor 240 may identify whether a condition for storing a second image (hereinafter, referred to as a “second image”) to be obtained through the camera 220 in a raw file format is satisfied, based on a first image (hereinafter, referred to as a “first image”) obtained through the camera 220.

In an embodiment, a raw file may include an uncompressed image. For example, the raw file may include image data for which a compression operation is not performed with respect to an image obtained through the camera 220. In an embodiment, an image stored in a raw file format may be an image (e.g., a lossless image) including all information about light input to an image sensor of the camera 220. In an embodiment, an image stored in the raw file format may include an image having a bit depth of 12-bit (or 14-bit) or 16-bit as an unprocessed image. In an embodiment, the raw file may have a DNG (digital negative) extension. However, the disclosure is not limited thereto, and an extension of the raw file may differ according to a manufacturer of the camera 220 or an image sensor. In an embodiment, although the raw file is described as an uncompressed image in the above-described example, the disclosure is not limited thereto. For example, the raw file may include a lossless compressed raw file or a compressed raw file.

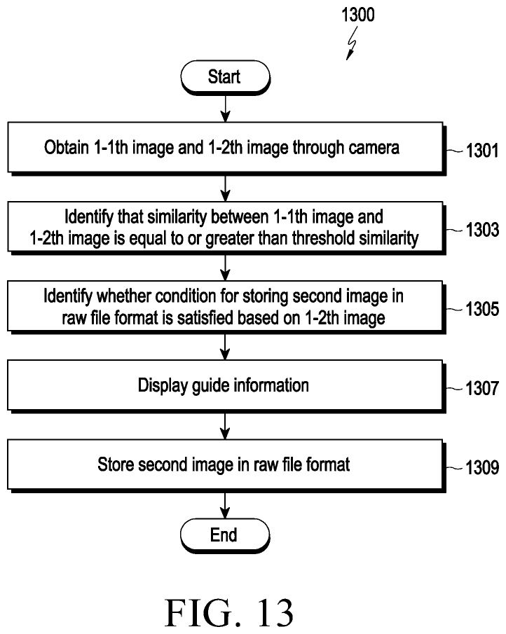

In an embodiment, the processor 240 may identify whether a condition for storing the second image in the raw file format is satisfied, based on a preview image as the first image. However, the disclosure is not limited thereto. For example, the processor 240 may identify whether a condition for storing the second image in the raw file format is satisfied, based on whether a plurality of images (e.g., a plurality of capture images) obtained before obtaining the second image satisfy a designated condition. This is described in detail with reference to FIG. 13.

In an embodiment, the processor 240 may identify whether a condition (hereinafter, referred to as a “first condition”) for storing the second image in the raw file format is satisfied, based on contrast of the first image (e.g., a difference between brightness of a brightest area and brightness of a darkest area in the first image). For example, the processor 240 may identify that the first condition is satisfied, based on a difference between brightness of a brightest area and brightness of a darkest area in the first image being equal to or greater than a threshold. For example, the processor 240 may identify that the first condition is not satisfied, based on a difference between brightness of a brightest area and brightness of a darkest area in the first image being less than a threshold.

In an embodiment, the processor 240 may identify whether the first condition is satisfied, based on brightness of the first image. For example, the processor 240 may identify that the first condition is satisfied, based on an average of brightness values of pixels of the first image being equal to or greater than a first threshold (e.g., when the first image is bright) or based on an average of brightness values of pixels of the first image being equal to or less than a second threshold (e.g., a second threshold less than the first threshold) (e.g., when the first image is dark). For example, the processor 240 may identify that the first condition is not satisfied, based on an average of brightness values of pixels of the first image exceeding the second threshold and being less than the first threshold.

In an embodiment, the processor 240 may identify whether the first condition is satisfied, based on noise of the first image. For example, the processor 240 may identify that the first condition is satisfied, based on an amount of noise of the first image being equal to or greater than a threshold. For example, the processor 240 may identify that the first condition is not satisfied, based on an amount of noise of the first image being less than a threshold.

In an embodiment, the processor 240 may identify that the first condition is satisfied, based on a capture mode of the camera 220 being set to a portrait capture mode or a night capture mode. However, the disclosure is not limited thereto. For example, the processor 240 may identify that the first condition is satisfied, based on identifying that a person is included in the first image or a capture environment of the first image is night, based on the first image.

However, the method for identifying whether a condition for storing the second image in a raw file format is satisfied is not limited to the above-described examples. For example, the first condition may include any condition in which storing the second image in the raw file format is more suitable than storing it in another format (e.g., a compressed file format).

In operation 1003, the processor 240 may display guide information for storing the second image in the raw file format upon obtaining the second image through the display 210, based on identifying that the condition (e.g., the first condition) is satisfied.

In an embodiment, the processor 240 may display guide information guiding the user to set a mode (hereinafter, also referred to as a “RAW capture mode”) for storing the second image in the raw file format upon obtaining the second image to be obtained through the camera 220 through the display 210, based on the first condition being satisfied. For example, at reference numeral 1101 of FIG. 11, the processor 240 may display a screen 1110 including an area displaying a preview image through the display 210. The processor 240 may display guide information 1121 prompting the user to active a RAW capture mode such as “Activate RAW now and take a picture. RAW image provides an uncompressed original image that is easy to correct, supporting you to capture your own photo” through the display 210, based on identifying that the first condition is satisfied based on the preview image.

In an embodiment, the processor 240 may display an object representing the RAW capture mode together with the guide information through the display 210, based on the first condition being satisfied. For example, at reference numeral 1102 of FIG. 11, the processor 240 may display a screen 1120 including an object 1122 (e.g., an object for activating the RAW capture mode) representing the RAW capture mode together with the guide information 1121 through the display 210, based on the first condition being satisfied.

In an embodiment, the processor 240 may activate the RAW capture mode, based on a user input for the object 1122. For example, at reference numerals 1102 and 1103 of FIG. 11, the processor 240 may activate the RAW capture mode, based on a user input for the object 1122. The processor 240 may display a screen 1130 including an object 1131 indicating that the RAW capture mode is activated through the display 210, when the RAW capture mode is activated.

In an embodiment, at reference numerals 1103 and 1104 of FIG. 11, the processor 240 may deactivate the RAW capture mode based on a user input for the object 1122, after the RAW capture mode is activated (e.g., in a state in which the RAW capture mode is activated). The processor 240 may display a screen 1140 including an object 1141 indicating that the RAW capture mode is deactivated through the display 210, when a RAW capture mode is deactivated.

In operation 1005, the processor 240 may obtain a second image based on a user input for an object 1112 for obtaining an image, and may store the obtained second image in a RAW file format in the memory 230, in a state in which the RAW capture mode is activated.

In an embodiment, the processor 240 may generate the second image in the RAW file format, and may generate the second image in a designated format (e.g., a JPEG (Joint Photographic Experts Group) format as a compressed file format), based on the second image being obtained in a state in which the RAW capture mode is activated. The processor 240 may store the second image generated in the RAW file format and the second image generated in the designated format in the memory 230.

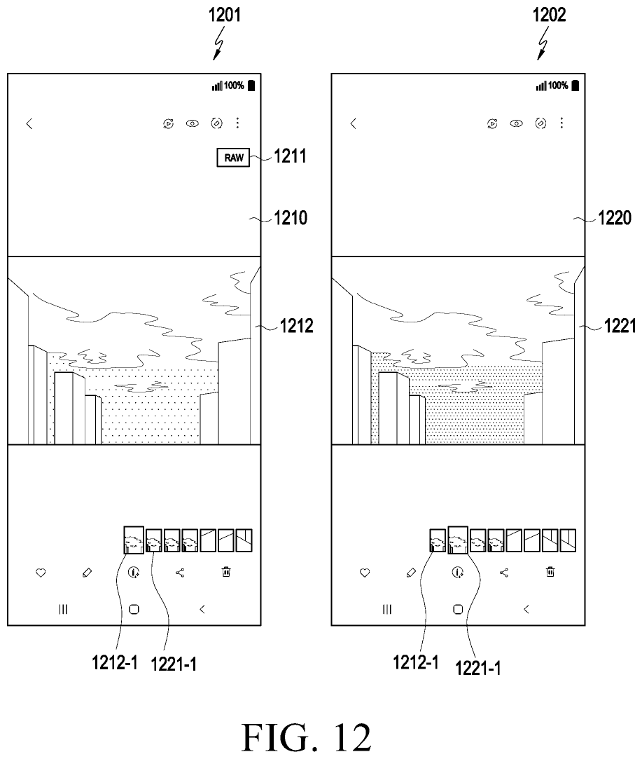

FIG. 12 is a view illustrating a method for storing an image, according to an embodiment.

Referring to FIG. 12, the processor 240 may store a second image obtained through the camera 220 in a RAW file format in the memory 230, in a state in which the RAW capture mode is activated.

In an embodiment, the processor 240 may display the second image stored in the RAW file format in the memory 230 through the display 210. For example, at reference numeral 1201 of FIG. 12, the processor 240 may display a screen 1210 including the second image 1212 stored in a RAW file format in the memory 230, an object 1211 indicating that the second image 1212 is an image stored in the RAW file format, and a thumbnail image 1212-1 of the second image 1212 through the display 210.

In an embodiment, the processor 240 may store the second image obtained through the camera 220 in the RAW file format in the memory 230, and may generate the second image in the JPEG format using a lossy compression method and store the second image generated in the JPEG format in the memory 230, in a state in which the RAW capture mode is activated.

In an embodiment, the processor 240 may display the second image stored in the JPEG file format in the memory 230 through the display 210. For example, at reference numeral 1202 of FIG. 12, the processor 240 may display a screen 1220 including the second image 1221 stored in the JPEG file format in the memory 230 and a thumbnail image 1221-1 of the second image 1221 through the display 210.

In the above-described examples, although it is described that the processor 240 generates the second image obtained through the camera 220 in both the RAW file format and the JPEG format and stores the second image generated in the RAW file format and the second image generated in the JPEG format in the memory 230 in a state in which the RAW capture mode is activated, the disclosure is not limited thereto. For example, the processor 240 may generate the second image obtained through the camera 220 in the RAW file format only, and may store the second image generated in the RAW file format in the memory 230, in a state in which the RAW capture mode is activated.

FIG. 13 is a flowchart 1300 describing a method for providing an image, according to an embodiment.

Referring to FIG. 13, in operation 1301, the processor 240 may obtain a 1-1th image (hereinafter, referred to as a “1-1th image”) and a 1-2th image (hereinafter, referred to as a “1-2th image”) through the camera 220.

In an embodiment, the 1-1th image and the 1-2th image may be images sequentially obtained (e.g., captured) through the camera 220. For example, the processor 240 may obtain the 1-1th image based on a user input (e.g., a user input for obtaining a capture image), when a preview image obtained through the camera 220 is displayed. After obtaining the 1-1th image, the processor 240 may display a preview image obtained through the camera 220. The processor 240 may obtain the 1-2th image based on a user input (e.g., a user input for obtaining a capture image), when a preview image, which is obtained through the camera 220, is displayed after obtaining the 1-1th image.

In an embodiment, the 1-2th image may be an image obtained through the camera 220 within a designated time from when the 1-1th image is obtained.

In an embodiment, the 1-2th image may be an image obtained through the camera 220 without switching the screen after obtaining the 1-1th image. For example, the processor 240 may obtain the 1-1th image through the camera 220, when an execution screen of a camera application is displayed. The processor 240 may determine the obtained image as the 1-2th image, when an image is obtained through the camera 220 without switching a screen displayed through the display 210 from a camera application to another screen (e.g., a home screen) after obtaining the 1-1th image.

In operation 1303, the processor 240 may identify whether a similarity between the 1-1th image and the 1-2th image is equal to or greater than a threshold similarity. For example, the processor 240 may compare the 1-1th image and the 1-2th image. The processor 240 may identify whether the similarity between the 1-1th image and the 1-2th image is equal to or greater than the threshold similarity, through the comparison. In an embodiment, a case where the similarity between the 1-1th image and the 1-2th image is equal to or greater than the threshold similarity may be a case where the 1-1th image and the 1-2th image include substantially the same scene. In an embodiment, a case where the similarity between the 1-1th image and the 1-2th image is equal to or greater than the threshold similarity may be a case where a user wants to capture the same scene a plurality of times.

In an embodiment, a condition that the similarity between the 1-1th image and the 1-2th image is equal to or greater than the threshold similarity may be referred to as a “second condition” or a “re-capture condition”.

In operation 1305, the processor 240 may identify whether a condition (e.g., the first condition) for storing the second image to be obtained through the camera 220 in the raw file format is satisfied, based on the 1-2th image (and/or the 1-1th image), based on the similarity between the 1-1th image and the 1-2th image being equal to or greater than the threshold similarity (e.g., based on the second condition being satisfied). Since the operation of identifying whether a condition for storing the second image to be obtained through the camera 220 in the raw file format is satisfied based on the 1-2th image (and/or the 1-1th image) is at least partially identical or similar to operation 1001 of FIG. 10, a detailed description thereof is omitted.

In operation 1307, the processor 240 may display guide information for storing the second image in the raw file format upon obtaining the second image through the display 210, based on identifying that a condition for storing the second image to be obtained through the camera 220 in the raw file format is satisfied, based on the 1-2th image (and/or the 1-1th image).

Since operation 1307 is at least partially identical or similar to operation 1003 of FIG. 10, a detailed description thereof is omitted.

In operation 1309, the processor 240 may store the second image in the RAW file format in the memory 230. For example, the processor 240 may obtain the second image based on a user input for an object 1112 for obtaining an image, and may store the obtained second image in the RAW file format in the memory 230, in a state in which a RAW capture mode is activated.

Since operation 1309 is at least partially identical or similar to operation 1005 of FIG. 10, a detailed description thereof is omitted.

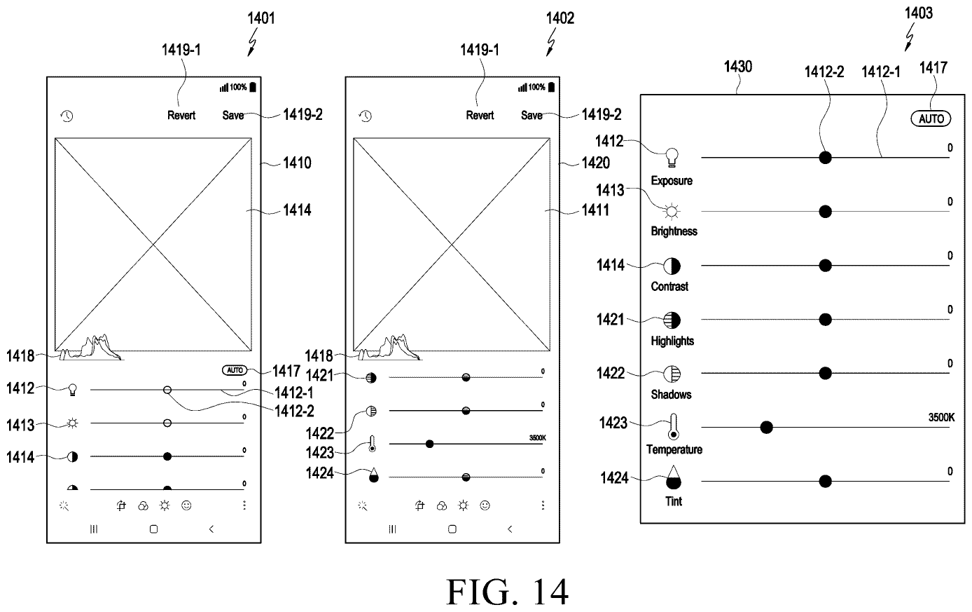

FIG. 14 is a view illustrating a method for correcting an image stored in a raw file format, according to an embodiment.

Referring to FIG. 14, the processor 240 may correct an image stored in the raw file format (hereinafter, also referred to as a “raw image”). For example, the processor 240 may correct or adjust a value of one or more attributes among values of a plurality of attributes of the raw image.

In an embodiment, at reference numerals 1401 and 1402 of FIG. 14, the processor 240 may display a screen (e.g., the screens 1410 and 1420) including an area 1411 in which the raw image is displayed and an interface for correcting the raw image through the display 210.

In an embodiment, the interface for correcting the raw image (hereinafter, also referred to as an “interface”) may include objects 1412, 1413, 1414, 1421, 1422, 1423, and 1424 representing a plurality of attributes, objects for adjusting the values of the plurality of attributes (e.g., the objects 1412-1 and 1412-2 for adjusting the value of the exposure), an object 1417 for automatically adjusting the values of the plurality of attributes, and/or a histogram 1418 related to an attribute of the raw image.

In an embodiment, at reference numerals 1401 and 1402 of FIG. 14, the processor 240 may display a portion of the interface through the display 210. The processor 240 may display another portion of the interface that is not displayed through the display 210 based on a user input for the interface (e.g., a user input for scrolling the interface for correcting the raw image), when the portion of the interface is displayed.

In an embodiment, the processor 240 may adjust at least one attribute value among a plurality of attribute values of the raw image based on a user input for the interface. For example, the processor 240 may adjust the exposure value (or the intensity of the exposure) by a user input for moving a position of an object 1412-2 (also referred to as a “slider”) movable along a bar-shaped object 1412-1.

In an embodiment, the processor 240 may control the display 210 such that objects for adjusting other attribute values may not be displayed, when one attribute value among a plurality of attribute values of the raw image is adjusted. For example, the processor 240 may control the display 210 such that only the objects 1412, 1412-1, and 1412-2 may be displayed and objects related to other attributes (e.g., attributes represented by the objects 1413, 1414, 1421, 1422, 1423, and 1424) disappear from the display 210, upon obtaining a user input for the object 1412-2 related to the exposure value (e.g., upon touching the object 1412-2).

In an embodiment, reference numeral 1403 of FIG. 14 may represent an interface 1430 for correcting the raw image. For example, the interface 1430 for correcting the raw image may include objects 1412, 1413, 1414, 1421, 1422, 1423, and 1424 representing a plurality of attributes, objects for adjusting the values of the plurality of attributes (e.g., the objects 1412-1, 1412-2 for adjusting the exposure value), and an object 1417 for automatically adjusting the values of the plurality of attributes.

In an embodiment, as illustrated at reference numeral 1403, the plurality of attributes of the raw image may include exposure, brightness, contrast, highlight, shadow, color temperature, and tint. However, the plurality of attributes of the raw image is not limited to the above-described examples. For example, the plurality of attributes of the raw image may further include chroma, sharpness, and/or clarity.

In an embodiment, the processor 240 may store the corrected raw image 1411 in the memory 230, based on a user input for an object 1419-2, after correcting the raw image 1411.

In an embodiment, the processor 240 may remove an effect (or a filter) applied to the corrected raw image 1411, based on a user input for an object 1419-1, after correcting the raw image 1411. For example, the processor 240 may restore the corrected raw image to a state without the applied effect or filter, based on a user input for the object 1419-1, after correcting the raw image 1411.

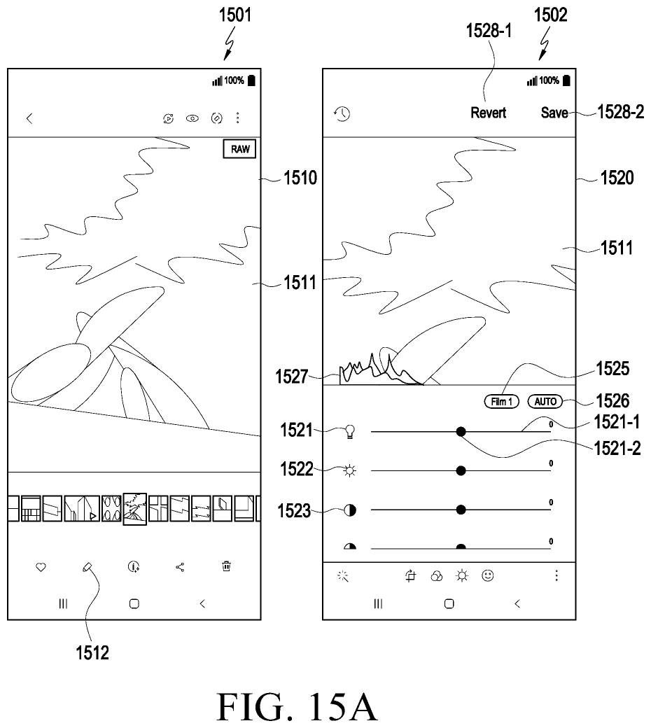

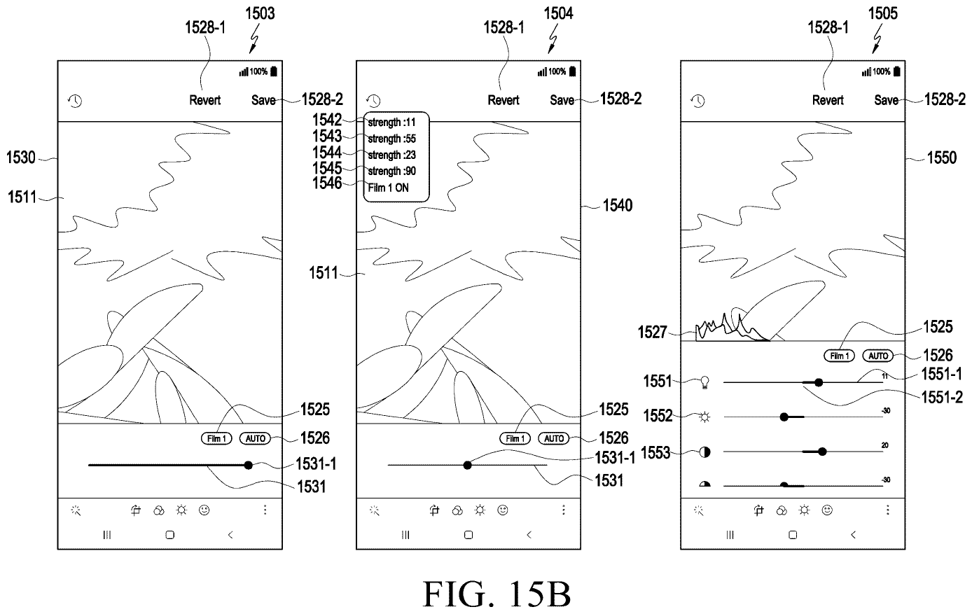

FIGS. 15A and 15B are views illustrating a method for correcting an image stored in a raw file format, according to an embodiment.

Referring to FIGS. 15A and 15B, the processor 240 may provide an application for correcting the raw image (e.g., a program for editing the raw image).

In an embodiment, the processor 240 may display the raw image through the display 210 based on a user input selecting the raw image, when a gallery application is executed. For example, the processor 240 may display a screen 1510 including the raw image 1511 through the display 210, at reference numeral 1501 of FIG. 15A.

In an embodiment, the processor 240 may execute an application for correcting the raw image (e.g., an application linked to a gallery application and capable of executing a function of correcting the raw image) based on a user input for correcting (or editing) the raw image, when the raw image is displayed. For example, the processor 240 may display a screen 1520 including an interface for correcting the raw image through the display 210 based on a user input for an object 1512 for correcting the raw image, at reference numerals 1501 and 1502 of FIG. 15A. In an embodiment, the interface may include objects (e.g., the objects 1521, 1522, and 1523) representing a plurality of attributes of the raw image 1511, objects (e.g., the objects 1521-1 and 1521-2) for adjusting the values of the plurality of attributes, an object 1526 for automatically adjusting the values of the plurality of attributes, an object 1525 representing a designated filter, and/or a histogram 1527 related to an attribute of the raw image.

In an embodiment, at reference numeral 1502 of FIG. 15A and reference numeral 1503 of FIG. 15B, the processor 240 may display a screen 1530 including objects 1531 and 1531-1 for adjusting an attribute value of a designated filter through the display 210, based on a user input for an object 1525 representing the designated filter.

In an embodiment, the designated filter may include a filter capable of executing a function (also referred to as a “film emulation function” or a “film simulation function”) which applies to the raw image an effect corresponding to image capture using film. However, the designated filter is not limited to the above-described example. Further, although FIGS. 15A and 15B describe an example of providing one designated filter, a plurality of designated filters may be provided.

In an embodiment, at reference numeral 1503, the processor 240 may adjust an intensity of the designated filter (e.g., a value of the designated filter) based on a user input for an object 1531-1 movable on a bar-shaped object 1531.

In an embodiment, the processor 240 may store the intensity of the designated filter in the memory 230. For example, at reference numeral 1503, the processor 240 may store the adjusted intensity of the designated filter in the memory 230, after adjusting the intensity of a designated filter (e.g., a filter with a filter name of “film 1”) based on a user input for the objects 1531 and 1531-1.

In an embodiment, the processor 240 may display the adjusted intensities of the designated filter (e.g., a history of the adjusted intensities of the designated filter) stored in the memory 230 through the display 210. For example, at reference numeral 1504, the processor 240 may display a screen 1540 including objects 1542, 1543, 1544, 1545, and 1546 representing each of the intensity 11, intensity 55, intensity 23, intensity 90, and intensity 100 (e.g., “film 1 on”) of the film 1 stored in the memory 230 through the display 210.

In an embodiment, the processor 240 may automatically adjust at least one attribute value among the values of the plurality of attributes of the raw image 1511, based on a user input for an object 1526 for automatically adjusting the values of the plurality of attributes. For example, at reference numerals 1504 and 1505, the processor 240 may automatically adjust a value of at least a portion of the attributes among the values of the plurality of attributes of the raw image 1511 such that the raw image 1511 may have optimized attribute values, based on a user input for the object 1526. The processor 240 may display a screen 1550 including a user interface (e.g., a user interface including the objects 1551, 1551-1, 1551-2, 1552, and 1553) representing the adjusted value of the attribute (e.g., the adjusted intensity of the attribute) through the display 210, when a value of at least a portion of the attributes among the values of the plurality of attributes of the raw image 1511 is adjusted.

In an embodiment, the processor 240 may store the corrected raw image 1511 in the memory 230, based on a user input for an object 1528-2, after correcting the raw image 1511.

In an embodiment, the processor 240 may remove an effect (or a filter) applied to the corrected raw image 1511, based on a user input for an object 1528-1, after correcting the raw image 1511. For example, the processor 240 may restore the corrected raw image, based on a user input for the object 1528-1, after correcting the raw image 1511.

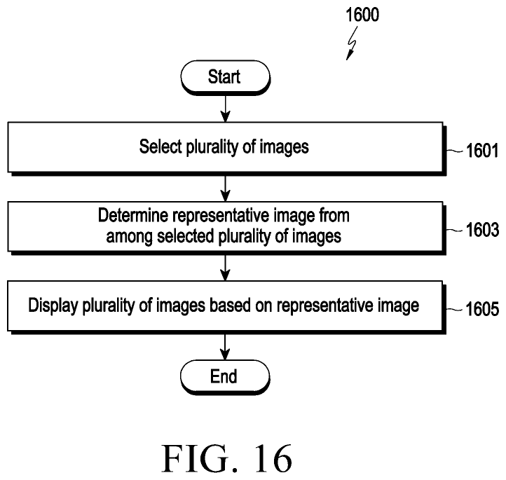

FIG. 16 is a flowchart illustrating a method for providing an image, according to an embodiment.

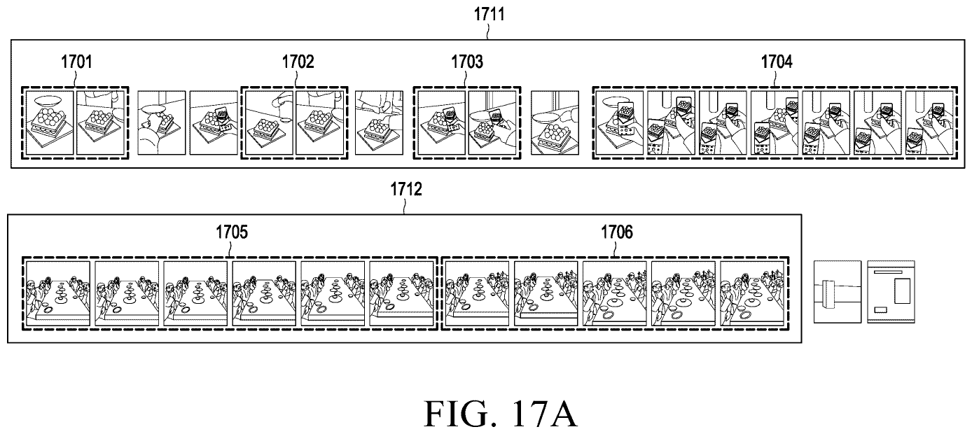

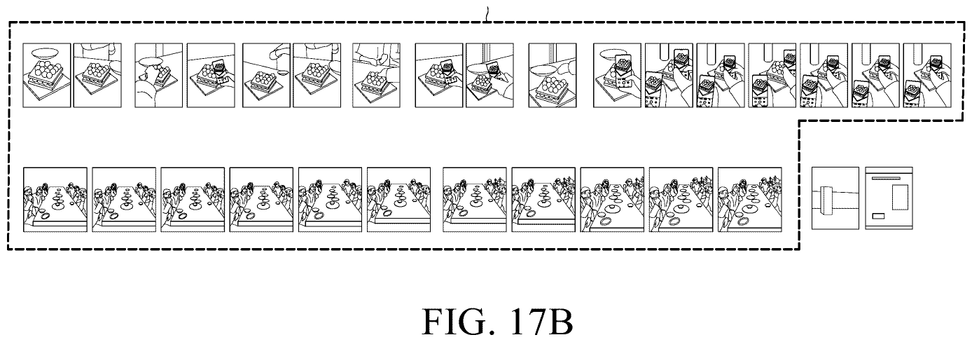

FIGS. 17A and 17B are views illustrating a method for providing an image, according to an embodiment.

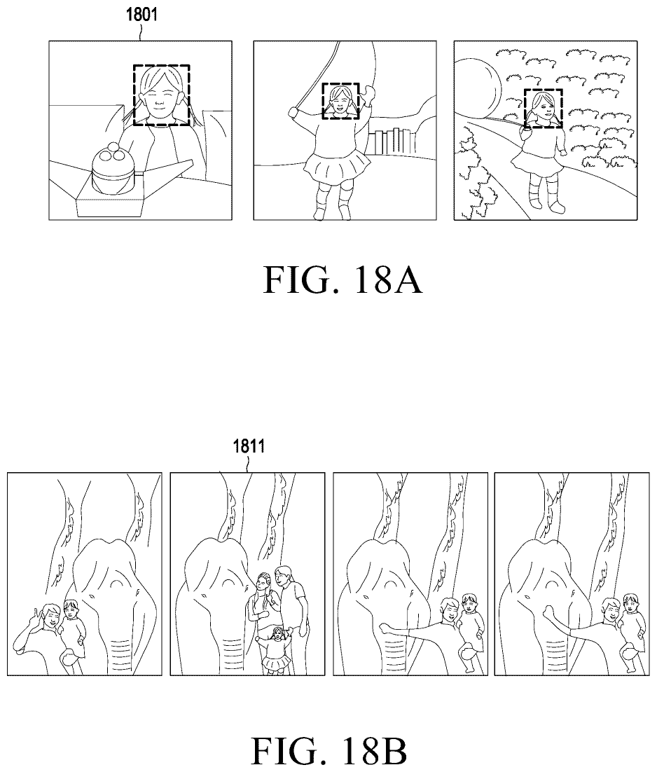

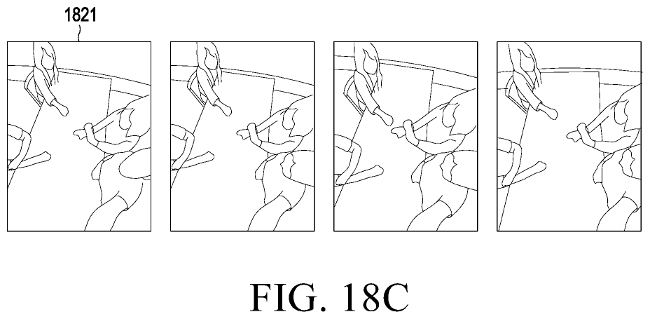

FIGS. 18A, 18B, and 18C are views illustrating a method for providing an image, according to an embodiment.

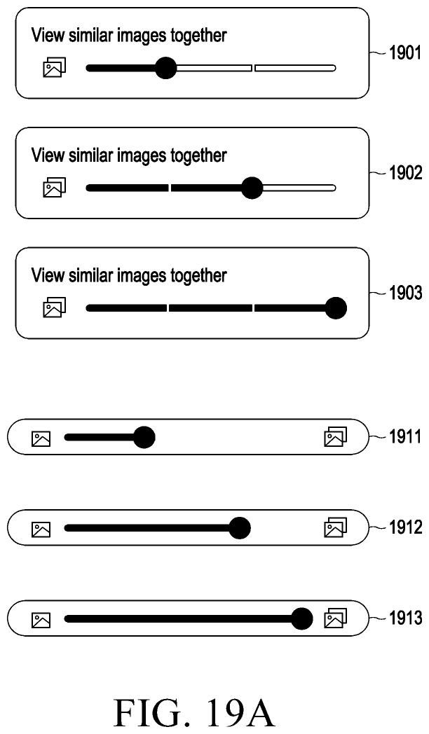

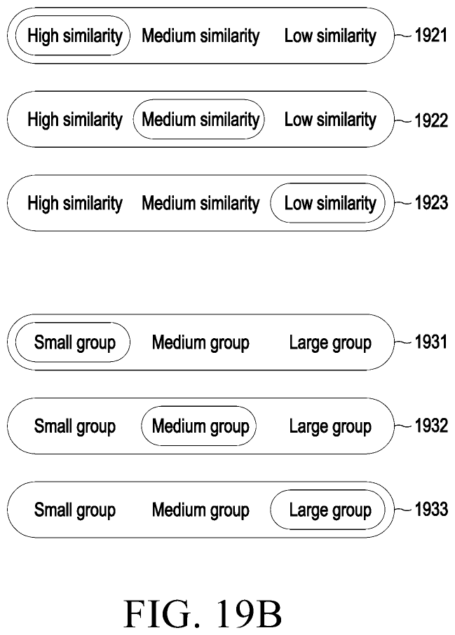

FIGS. 19A and 19B are views illustrating a method for providing an image, according to an embodiment.

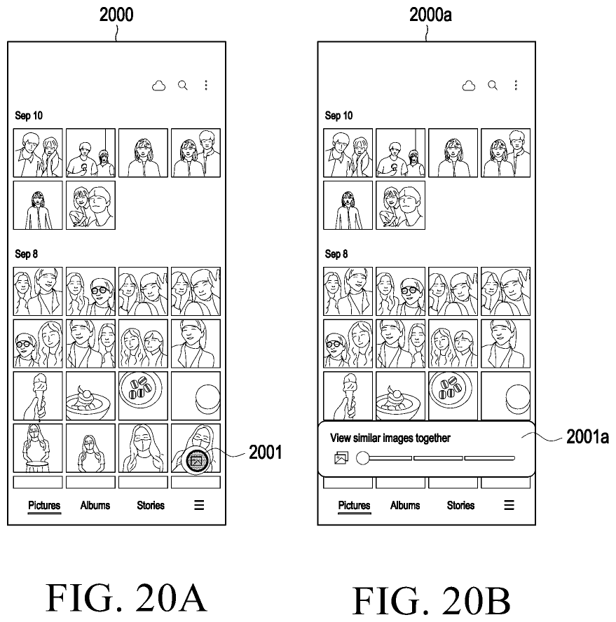

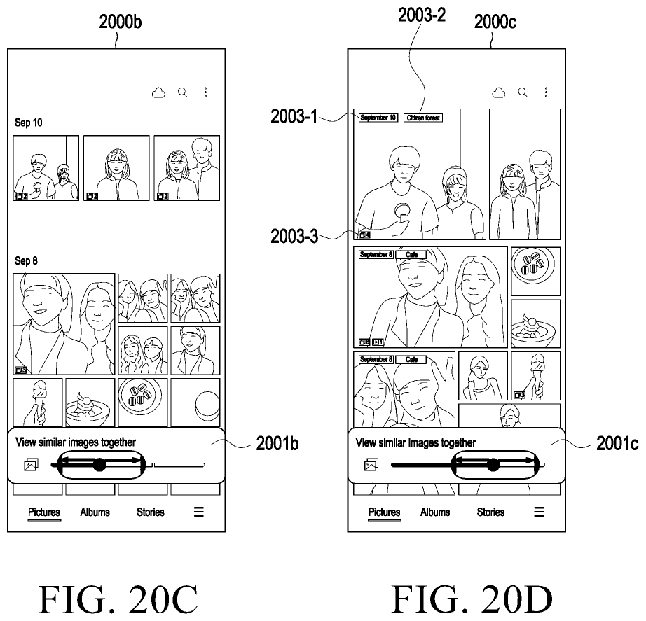

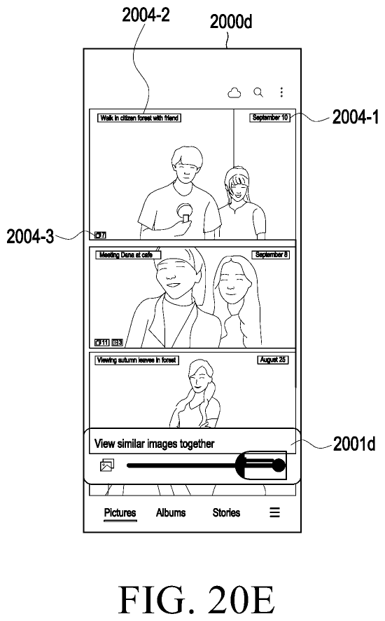

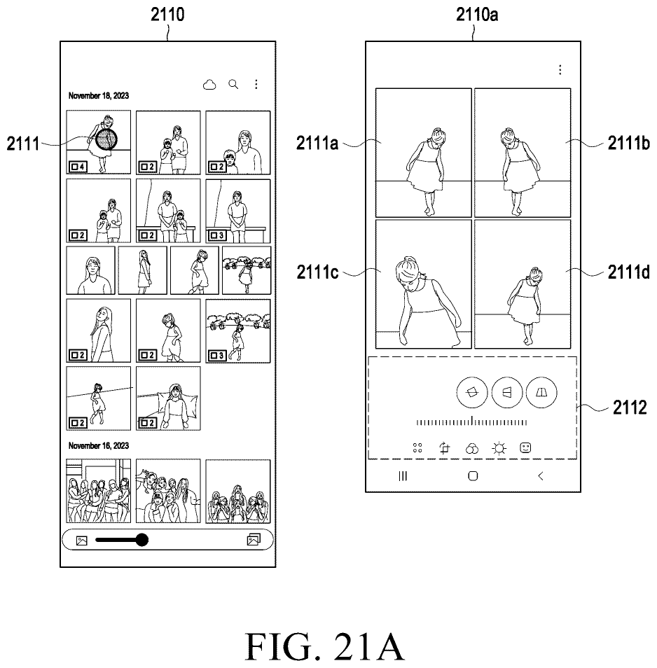

FIGS. 20A, 20B, 20C, 20D, and 20E are views illustrating a method for providing an image, according to an embodiment.

Referring to FIG. 16 17A and 17B, in operation 1601, the processor 240 may select a plurality of images based on a user input.

In an embodiment, the processor 240 may display images stored in the memory 230 through the display 210, based on execution of an image application (e.g., a gallery application). In an embodiment, the images stored in the memory 230 may include one or more still images and/or one or more moving images. The processor 240 may select a plurality of images (hereinafter, referred to as “a plurality of images”) from among the images, based on a user input selecting an image collection view function.

The processor 240 may perform an analysis for similarity comparison with respect to the stored images, based on a user input selecting a similarity level among the image collection view function. The processor 240 may select a plurality of images having the same similarity level based on a capture time, a capture background and composition, a pose and expression of a subject, a capture location, or the like. In an embodiment, the similarity level may be determined based on a user input. For example, the processor 240 may perform an analysis for similarity comparison with respect to the stored images, based on any one similarity level among high, medium, and low similarity levels, based on a user input selected by a slider method, as illustrated at reference numerals 1901 to 1903 and 1911 to 1913 of FIG. 19A. In an embodiment, the low similarity level may mean a timeline bookmark function, which is a function for viewing images collected based on time information where the images are captured. For example, the processor 240 may perform an analysis for similarity comparison with respect to the stored images, based on any one similarity level among high, medium, and low similarity levels, based on a user input selected by a button selection method, as illustrated at reference numerals 1921 to 1923 and 1931 to 1933 of FIG. 19B. In an embodiment, the low similarity level may mean a timeline bookmark function, which is a function for viewing images collected based on time information where the images are captured. For example, the processor 240 may set the similarity level high, medium, or low, based on a user input corresponding to a pinch in/out operation.

In an embodiment, when the high similarity level is selected among the image collection view function, the processor 240 may select a plurality of images including the same subject captured within a predetermined/certain range (e.g., within a radius of 1 km), having a capture time within a predetermined/certain time (e.g., 3 minutes) and a capture background and composition having a similarity of a predetermined/certain ratio (e.g., 80%) or more, and having a pose and expression of the subject having a similarity of a predetermined/certain ratio (e.g., 80%) or more, as illustrated at reference numerals 1701 to 1706 of FIG. 17A.

In an embodiment, when the medium similarity level is selected among the image collection view function, the processor 240 may select a plurality of images captured within a predetermined/certain range (e.g., within a radius of 1 km), having a capture time within a predetermined/certain time (e.g., 1 minute) and a capture background and composition having a similarity of a predetermined ratio (e.g., 50%) or more, and having a pose and expression of the subject having a similarity of a predetermined/certain ratio (e.g., 50%) or more, as illustrated at reference numerals 1711 and 1712 of FIG. 17A.

In an embodiment, when a timeline bookmark function is selected among the image collection view function, the processor 240 may select a plurality of images having attributes related to the same event, as illustrated at reference numeral 1721 of FIG. 17B. In an embodiment, a plurality of images having attributes related to the same event may be images captured at the same location on the same date. In an embodiment, a plurality of images having attributes related to the same event may be images including persons having an exposure frequency of a predetermined/certain range or more (e.g., top 20%) among persons stored in an image application (e.g., a gallery application). In an embodiment, a location where a plurality of images having attributes related to the same event are captured may have a coincidence ratio of a predetermined/certain ratio or less (e.g., 20% or less) with locations of images stored in the memory 230. For example, the processor 240 may select a plurality of images captured at a location that is not a location where images are frequently captured.

In an embodiment, the processor 240 may select a plurality of images including the corresponding moving image based on similarity based on photo images before and after the moving image is captured, in a case of a moving image among the stored images.

In operation 1603, the processor 240 may determine the representative image based on attribute values of the plurality of images.

In an embodiment, the processor 240 may determine the representative image from among the plurality of images based on attribute values (e.g., whether or not a favorite selection is made, a frequency where an image is selected for editing or sharing, whether an image is edited after being captured, whether a specific person or subject is included in an image, a time when the image is captured, etc.) of the plurality of images (e.g., a plurality of images selected in operation 1601).

In an embodiment, the processor 240 may analyze or extract the values of the plurality of attributes of the plurality of images with respect to each of the plurality of attributes. The processor 240 may determine the representative image from among the plurality of images based on a predetermined/certain priority with respect to each of the plurality of attributes.

For example, the processor 240 may determine an image having a favorite attribute value among the plurality of images as the representative image. The favorite attribute value may be set based on a user input.

For example, the processor 240 may determine an image having a highest frequency where the image is selected for editing or sharing among the plurality of images as the representative image.

For example, the processor 240 may determine an image in which the most attribute values are changed and edited after image capture among the plurality of images as the representative image.

For example, the processor 240 may determine an image including a specific person or subject among the plurality of images as the representative image. When there are a plurality of images including a specific person or subject, the processor 240 may determine an image in which a specific person or subject occupies the highest ratio in an entire image as the representative image, as illustrated at reference numeral 1801 of FIG. 18A, or may determine an image in which the largest number of persons or the number of subjects including a specific person or subject is included as the representative image, as illustrated at reference numeral 1811 of FIG. 18B.

For example, the processor 240 may determine an image captured most recently among the plurality of images as the representative image.

In an embodiment, the processor 240 may determine an image including a plurality of persons belonging to the same group among persons stored in an image application (e.g., a gallery application) as the representative image, from among the plurality of images. In an embodiment, when there are a plurality of images including a plurality of persons, the processor 240 may determine an image including the largest number of persons or an image including the most persons looking at a camera as the representative image, as illustrated at reference numeral 1821 of FIG. 18C.

However, the method for determining the representative image is not limited to the above-described examples.

In operation 1605, the processor 240 may display a screen including the representative image and the plurality of images through the display 210, when a plurality of images is selected from among the images and the representative image being selected. The processor 240 may display objects indicating that the plurality of images are selected with a collection view function within the representative images of each of the plurality of images, together with the plurality of images, through the display 210.

In an embodiment, the objects displayed within the representative images of each of the plurality of images may represent the number of a plurality of images grouped in the same group, date information where images are captured, and a caption representing a common event of the images. For example, the processor 240 may display images stored in the memory 230 and an object 2001 representing an image collection view function through the display 210, based on execution of an image application (e.g., a gallery application), as illustrated at reference numeral 2000.

The processor 240 may display an object 2001a capable of selecting a similarity level through the display 210, when an image collection view function is selected by a user input, as illustrated at reference numeral 2000a of FIG. 20B. The processor 240 may display a plurality of images selected based on the high similarity level as one group and an object 2001b indicating that the high similarity level is selected through the display 210, when the high similarity level is selected by a user input, as illustrated at reference numeral 2000b of FIG. 20C. The processor 240 may display an object 2003-3 representing the number of a plurality of images included in the group on each of the representative images of the plurality of images included in one group.

The processor 240 may group a plurality of images selected based on the medium similarity level as one group and display the representative image selected from among the plurality of images included in one group through the display 210 and an object 2001c indicating that the medium similarity level is selected, when the medium similarity level is selected by a user input, as illustrated at reference numeral 2000c of FIG. 20D. The processor 240 may display an object 2003-1 representing a date where the plurality of images included in the group are captured, an object 2003-2 representing event content of the plurality of images, and an object 2003-3 representing the number of the plurality of images on each of the representative images of the plurality of images included in one group. In an embodiment, the object 2003-2 representing event content of the plurality of images may represent location information where the plurality of images are captured.

The processor 240 may display images 2000d of FIG. 20E through the display 210, when a low similarity level (e.g., timeline bookmark) is selected by a user input, and may display images 2000c of FIG. 20D through the display 210 when the similarity level is changed to medium by a user input, and may display images 2000b of FIG. 20C through the display 210 when the similarity level is changed to high by a user input.

Although FIGS. 20A, 20B, 20C, 20D, and 20E describe a sliding method as a method for selecting a similarity level, a button selection method or a pinch in/out method may also be used.

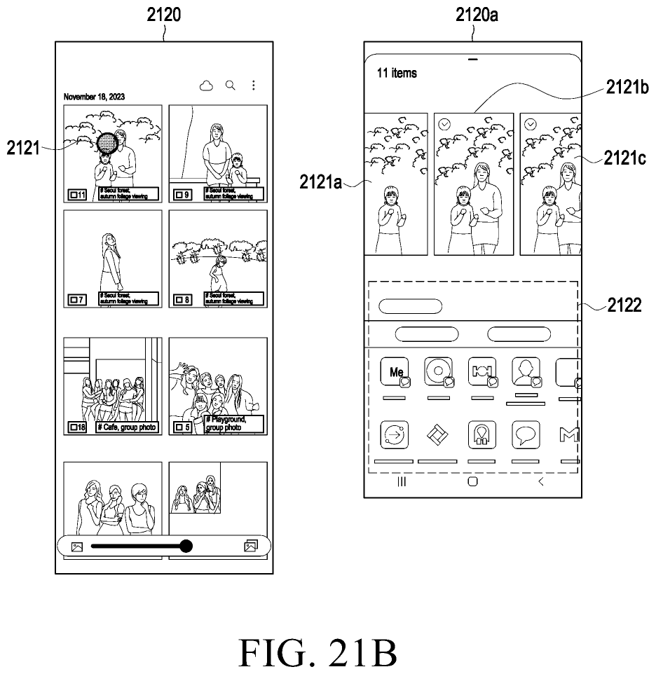

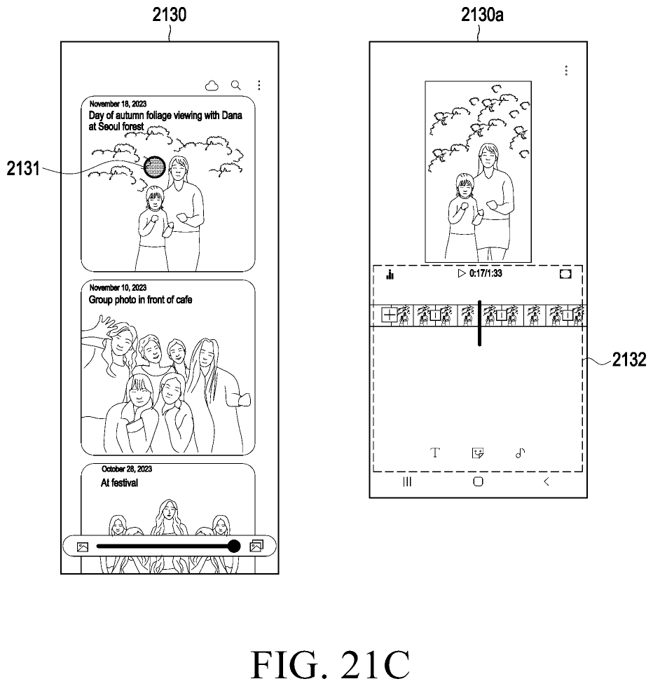

FIGS. 21A, 21B, and 21C are views illustrating a method for providing an image, according to an embodiment.

Referring to FIG. 21A, the processor 240 may display a screen 2110 including a plurality of images stored in the memory 230 through the display 210, based on an image collection view function being executed with a high similarity level. The processor 240 may select a first image 2111 from among representative images of each of a plurality of image groups based on a user input, when the representative images of each of a plurality of image groups are displayed according to an image collection view function being executed. The processor 240 may display a screen 2110a including a plurality of images 2111a, 2111b, 2111c, and 2111d having the first image 2111 as the representative image and objects (or a user interface) 2112 (e.g., icons) for collectively adjusting values of a plurality of attributes of the plurality of images 2111a, 2111b, 2111c, and 2111d within the display 210 through the display 210, when the first image 2111 is selected from among the representative images of each of the plurality of image groups. A specific method for collectively adjusting the values of the plurality of attributes of the plurality of images 2111a, 2111b, 2111c, and 2111d may follow the method described in connection with FIG. 6. In an embodiment, when the plurality of images 2111a, 2111b, 2111c, and 2111d identically include an unnecessary subject, the processor 240 may collectively delete the corresponding subject from the plurality of images 2111a, 2111b, 2111c, and 2111d based on a user input. The processor 240 may display a user interface allowing a user to select whether to collectively delete the corresponding subject from the plurality of images 2111a, 2111b, 2111c, and 2111d, based on a user input for deleting the corresponding subject from the representative image of the plurality of images 2111a, 2111b, 2111c, and 2111d, within the display 210. In an embodiment, the processor 240 may display the corrected plurality of images through the display 210, based on the plurality of images being corrected.

Referring to FIG. 21B, the processor 240 may display a screen 2120 including a plurality of images stored in the memory 230 through the display 210, based on an image collection view function being executed with a medium similarity level. The processor 240 may select the second image 2121 from among the representative images of each of a plurality of image groups based on a user input, when the representative images of each of a plurality of image groups are displayed according to an image collection view function being executed. The processor 240 may display a screen 2120a including a plurality of images 2121a, 2121b, and 2121c having the second image 2121 as the representative image and objects (or a user interface) 2122 (e.g., icons) for collectively sharing the plurality of images 2121a, 2121b, and 2121c within the display 210 through the display 210, when the second image 2121 is selected from among the representative images of each of the plurality of image groups. In an embodiment, the processor 240 may exclude a portion of the plurality of images 2121a, 2121b, and 2121c from images to be collectively shared, based on a user input.

Referring to FIG. 21C, the processor 240 may display a screen 2130 including a plurality of images stored in the memory 230 through the display 210, based on an image collection view function being executed with a low similarity level (e.g., timeline bookmark). The processor 240 may select a third image 2131 from among the representative images of each of a plurality of image groups based on a user input, when the representative images of each of a plurality of image groups are displayed according to an image collection view function being executed. The processor 240 may display a screen 2130a including a plurality of images having the third image 2131 as the representative image and objects (or a user interface) 2132 (e.g., icons) for generating a moving image from the plurality of images within the display 210 through the display 210, when the third image 2131 is selected from among the representative images of each of the plurality of image groups. In an embodiment, the processor 240 may exclude a portion of the plurality of images having the third image 2131 as the representative image from the moving image, based on a user input.

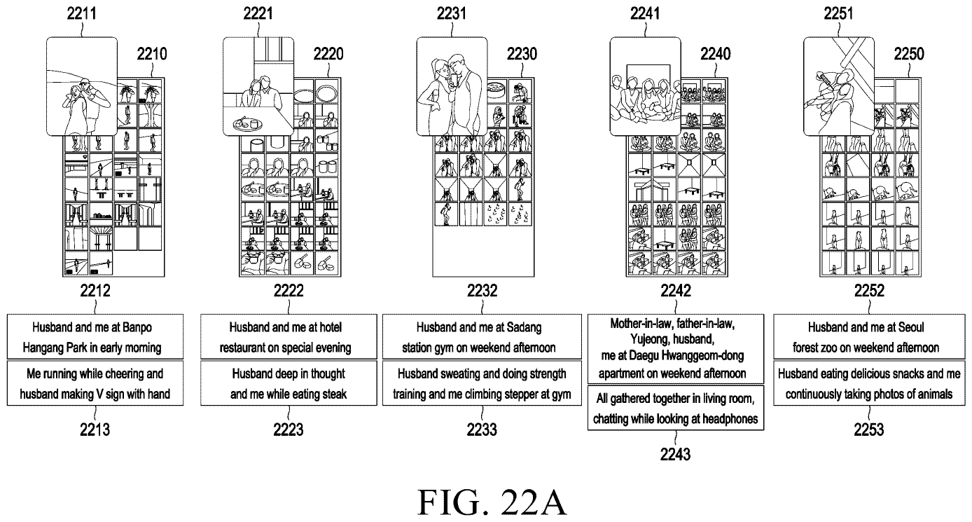

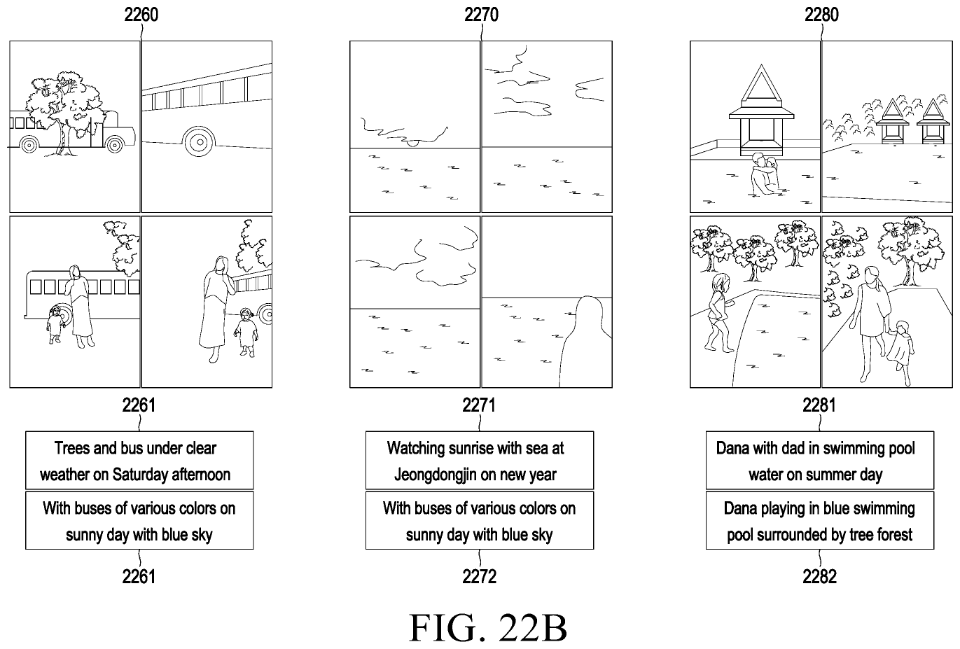

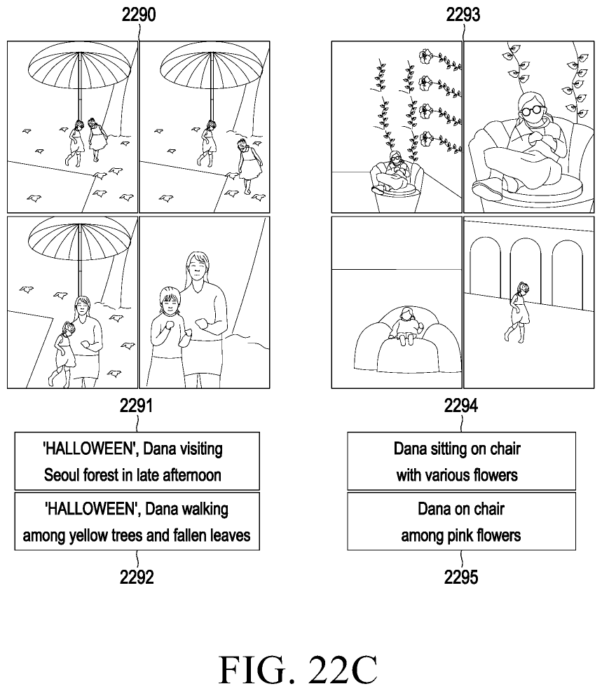

FIGS. 22A, 22B, and 22C are views illustrating a method for generating and displaying a caption for a plurality of images selected based on an image collection view function, according to an embodiment.

The processor 240 may analyze a plurality of images selected based on an image collection view function and generate a caption for each of a plurality of image groups. In an embodiment, the processor 240 may generate caption content differently according to level 1 and level 2. A caption generated based on level 2 may include more specific information about a plurality of images compared to level 1.

Referring to FIG. 22A, the processor 240 may detect an event of a plurality of image groups by analyzing a plurality of images selected based on an image collection view function, or may detect metadata information such as a location, a date, or the like where the plurality of images are captured, or may detect a person, a subject commonly included in the plurality of images, or may detect a common expression, an action, or the like of a person, a subject commonly included in the plurality of images, and may generate level 1 captions 2212, 2222, 2232, 2242, and 2252 or level 2 captions 2213, 2223, 2233, 2243, and 2253 based on the detected information.

Referring to FIG. 22B, the processor 240 may analyze an action, an expression, an object, a location, a time, weather, a season, a color, brightness, chroma, event content, or the like included in the plurality of images, and generate a caption based on the analyzed content, according to determining that the plurality of images include a background image of a predetermined/certain ratio or more by analyzing a plurality of images selected based on an image collection view function. The processor 240 may refer to content stored in an application related to an event (e.g., a calendar application).

The plurality of image groups represented by reference numerals 2260, 2270, and 2280 of FIG. 22B may each include a plurality of selected images. The processor 240 may analyze an action, an expression, an object, a location, a time, weather, a season, a color, brightness, chroma, or the like included in the plurality of images, and may generate level 1 captions 2261, 2271, and 2281 or level 2 captions 2262, 2272, and 2282 based on the analyzed content and a caption level setting. In an embodiment, the caption level may be determined according to a user input.

Referring to FIG. 22C, the processor 240 may analyze text, an action, an expression, an object, a location, a time, weather, a season, a color, brightness, chroma, event content, or the like included in the plurality of images, and generate a caption based on the analyzed content, according to determining that the plurality of images include a background image and text of a predetermined/certain ratio or more by analyzing a plurality of images selected based on an image collection view function. The processor 240 may refer to content stored in an application related to an event (e.g., a calendar application).

The plurality of image groups represented by reference numerals 2290 and 2293 of FIG. 22C may each include a plurality of selected images. The processor 240 may analyze text, an action, an expression, an object, a location, a time, weather, a season, a color, brightness, chroma, or the like included in the plurality of images, and may generate level 1 captions 2291, 2294 or level 2 captions 2292, 2295 based on the analyzed content and a caption level setting. In an embodiment, the caption level may be determined according to a user input.

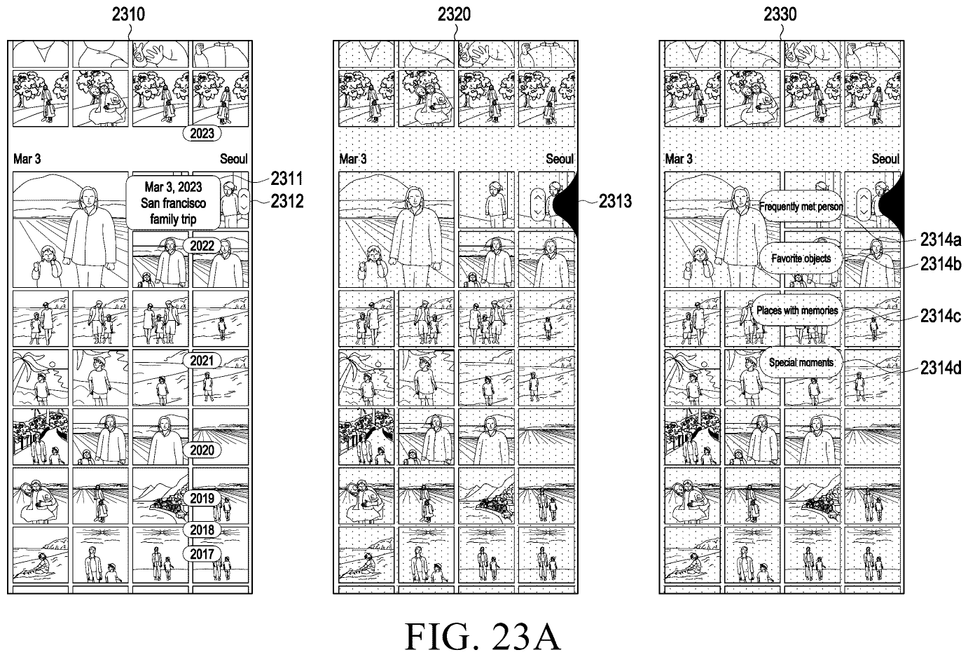

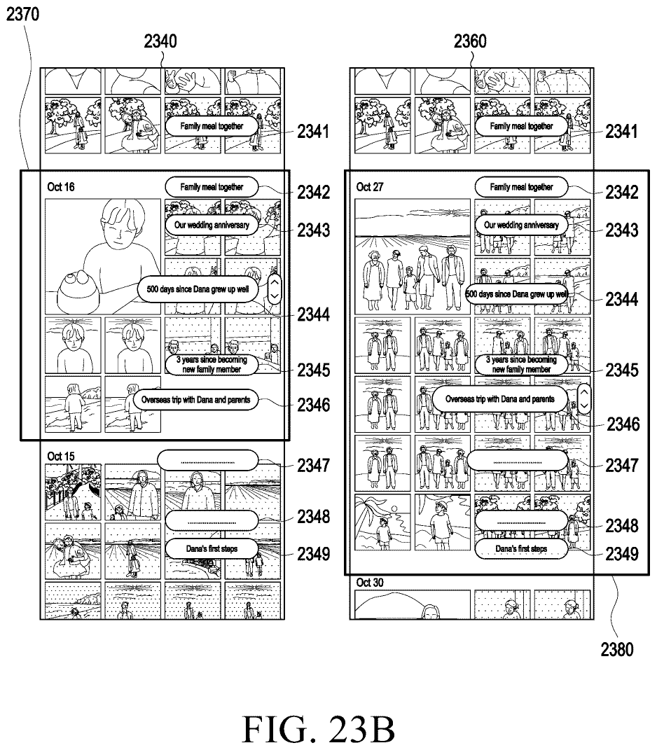

FIGS. 23A, 23B, 24, and 25 are views illustrating a method for providing an image, according to an embodiment.

Referring to FIG. 23A, the processor 240 may display images stored in the memory 230 through the display 210, based on execution of an image application (e.g., a gallery application), as illustrated at reference numeral 2310 of FIG. 23A. The processor 240 may display a scroll object 2312 together with images for quick navigation of images, upon displaying images stored in the memory 230 through the display 210. In an embodiment, the processor 240 may display a simple caption 2311 for corresponding images based on a current position of the scroll object 2312 through the display 210. For example, the caption 2311 may include a date and a location where the corresponding images are captured, and simple event information (e.g., a family trip). The information displayed in the caption 2311 is not limited thereto.

In an embodiment, based on a left push operation 2313 for the scroll object occurring as illustrated at reference numeral 2320 of FIG. 23A by a user input, the processor 240 may display objects 2314a, 2314b, 2314c, and 2314d representing option functions for scroll switching through the display 210, as illustrated at reference numeral 2330 of FIG. 23A. Although FIG. 23A illustrates that frequently met person (person), favorite objects, places with memories, and special moments (events) are provided as option functions for scroll switching, the disclosure is not limited thereto, and the processor 240 may analyze images stored in the memory 230 and provide various option functions for scroll switching. In an embodiment, the processor 240 may display images meeting each of the option functions for scroll switching selected based on a user input through the display 210.

Referring to FIG. 23B, when a frequently met person is selected among the option functions for scroll switching selected based on a user input, the processor 240 may display images including a person through the display 210, as illustrated at reference numeral 2340. In an embodiment, the processor 240 may display captions 2341 to 2349 matching each of the images displayed through the display 210 together with the images, and may display a caption 2344 corresponding to images 2370 at a current scroll object position differently from other captions 2341 to 2343, 2345 to 2349 in terms of color and font size of the caption 2344. In an embodiment, the processor 240 may display a caption 2346 corresponding to images 2380 at a current scroll object position differently from other captions 2341 to 2345, 2347 to 2349 in terms of color and font size of the caption 2346, based on a user input for moving a scroll downward, as illustrated at reference numeral 2360.

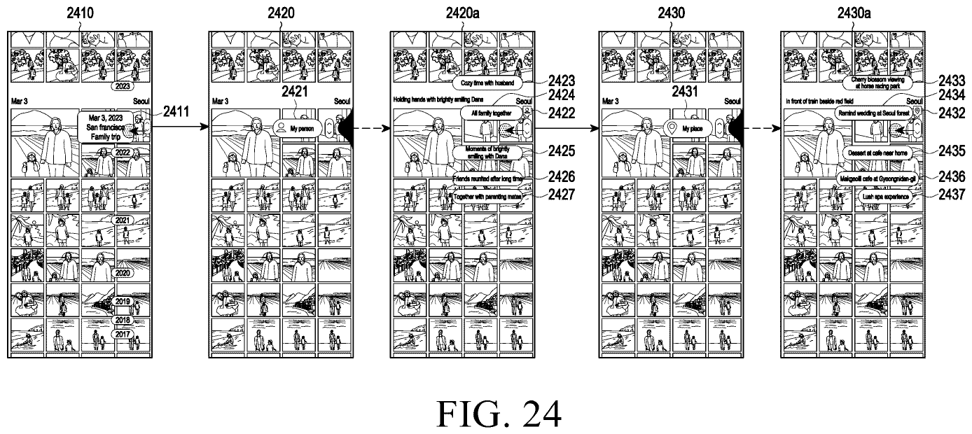

Referring to FIG. 24, the processor 240 may display images stored in the memory 230 through the display 210, based on execution of an image application (e.g., a gallery application), as illustrated at reference numeral 2410 of FIG. 24. The processor 240 may display a scroll object together with images for quick navigation of images, upon displaying images stored in the memory 230 through the display 210. In an embodiment, the processor 240 may display a simple caption 2411 for corresponding images based on a current position of the scroll object through the display 210. For example, the caption 2411 may include a date and a location where the corresponding images are captured, and simple event information (e.g., a family trip). The information displayed in the caption 2411 is not limited thereto.

In an embodiment, based on a left push operation for the scroll object occurring as illustrated at reference numeral 2420 of FIG. 24 by a user input, the processor 240 may display objects representing option functions for scroll switching through the display 210. In an embodiment, the processor 240 may display images meeting my person 2421 among the option functions for scroll switching selected based on a user input through the display 210.

In an embodiment, the processor 240 may display captions 2423 to 2427 matching each of the images displayed through the display 210 together with the images, and may display captions 2424 and 2425 corresponding to images at a current scroll object position differently from other captions 2423, 2426, and 2427 in terms of color and font size of the caption 2424 and 2425. In an embodiment, the processor 240 may display an object 2422 representing a currently selected option function for scroll switching together with the scroll object through the display 210.

In an embodiment, the processor 240 may display images meeting my place among the option functions for scroll switching selected based on a user input through the display 210, as illustrated at reference numeral 2430.

In an embodiment, the processor 240 may display captions 2433 to 2437 matching each of the images displayed through the display 210 together with the images, and may display captions 2434 and 2435 corresponding to images at a current scroll object position differently from other captions 2433, 2436, and 2437 in terms of color and font size of the caption 2434 and 2435. In an embodiment, the processor 240 may display an object 2432 representing a currently selected option function for scroll switching together with the scroll object through the display 210.

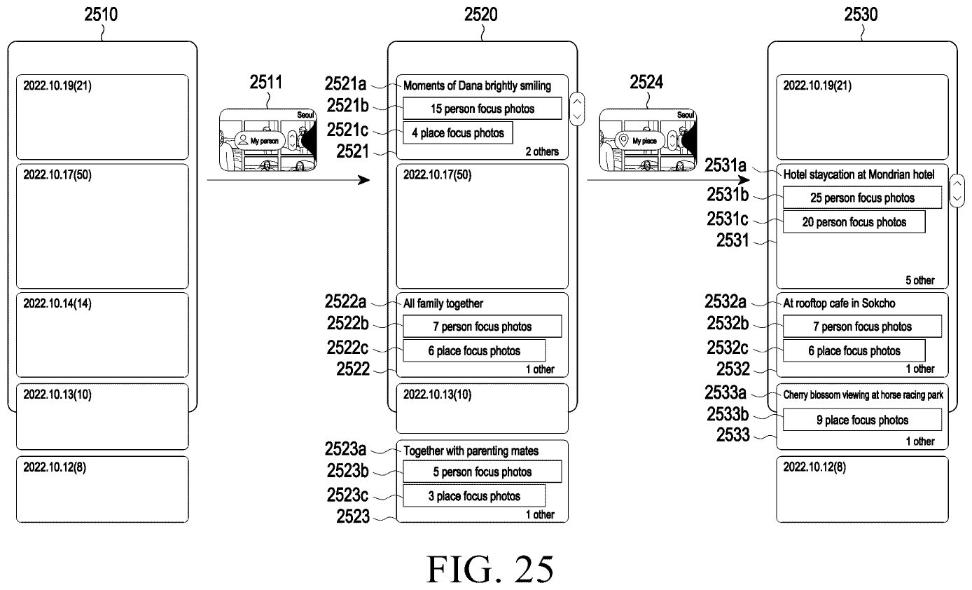

Referring to FIG. 25, the processor 240 may display images stored in the memory 230 disposed in order of captured dates through the display 210, based on execution of an image application (e.g., a gallery application), as illustrated at reference numeral 2510 of FIG. 25.

In an embodiment, based on a left push operation for the scroll object occurring as illustrated at reference numeral 2511 by a user input, the processor 240 may display objects representing option functions for scroll switching through the display 210.

In an embodiment, the processor 240 may display indicators 2521, 2522, and 2523 for person highlight points in areas including images meeting my person among the option functions for scroll switching selected based on a user input through the display 210, as illustrated at reference numeral 2520. In an embodiment, the processor 240 may display a caption in each of the areas including images meeting my person, as illustrated at reference numerals 2521a, 2522a, and 2523a, so that a user may quickly search for a desired photo. In an embodiment, the processor 240 may display the number of photos focused on a person among the images included in each of the areas including images meeting my person, as illustrated at reference numerals 2521b, 2522b, and 2523b. In an embodiment, the processor 240 may display the number of photos focused on a location among the images included in each of the areas including images meeting my person, as illustrated at reference numerals 2521c, 2522c, and 2523c.

In an embodiment, based on a left push operation for the scroll object occurring as illustrated at reference numeral 2524 by a user input, the processor 240 may display objects representing option functions for scroll switching through the display 210.

In an embodiment, the processor 240 may display indicators 2531, 2532, and 2533 for location highlight points in areas including images meeting my place among the option functions for scroll switching selected based on a user input through the display 210, as illustrated at reference numeral 2530. In an embodiment, the processor 240 may display a caption in each of the areas including images meeting my place, as illustrated at reference numerals 2531a, 2532a, and 2533a, so that a user may quickly search for a desired photo. In an embodiment, the processor 240 may display the number of photos focused on a location among the images included in each of the areas including images meeting my place, as illustrated at reference numerals 2531b, 2532b, and 2533b. In an embodiment, the processor 240 may display the number of photos focused on a person among the images included in each of the areas including images meeting my place, as illustrated at reference numerals 2531c and 2532c.

In an embodiment, the processor 240 may extract images meeting my place based on a capture date, a person, or a location of images stored in the memory 230. For example, when the number of images captured on a specific date exceeds a predetermined/certain ratio (e.g., 1.5 times) of an average value of the number of images captured on other dates, and images captured on the corresponding date include persons having an exposure frequency of a predetermined/certain range or more (e.g., top 20%) among persons stored in an image application (e.g., a gallery application), or images captured on the corresponding date are captured at a location outside a main activity range of a user, the processor 240 may extract images captured on the corresponding date as images meeting my place. In an embodiment, the processor 240 may extract images captured within a predetermined/certain time (e.g., within 1 hour) and within a predetermined/certain location range (e.g., within a radius of 1 km) among images captured on the corresponding date as images meeting my place. In an embodiment, when there are a plurality of image groups satisfying the same condition, the processor 240 may extract an image group having the largest number of images belonging to each image group.

In an embodiment, the processor 240 may generate a caption for the extracted image group, wherein the processor 240 may analyze persons included in images belonging to the extracted image group and main actions and characteristics, a location of the persons, or the like, and display the analyzed information as a caption. In an embodiment, the processor 240 may display names of the persons used in the caption as names of the persons stored in an image application (e.g., a gallery application).

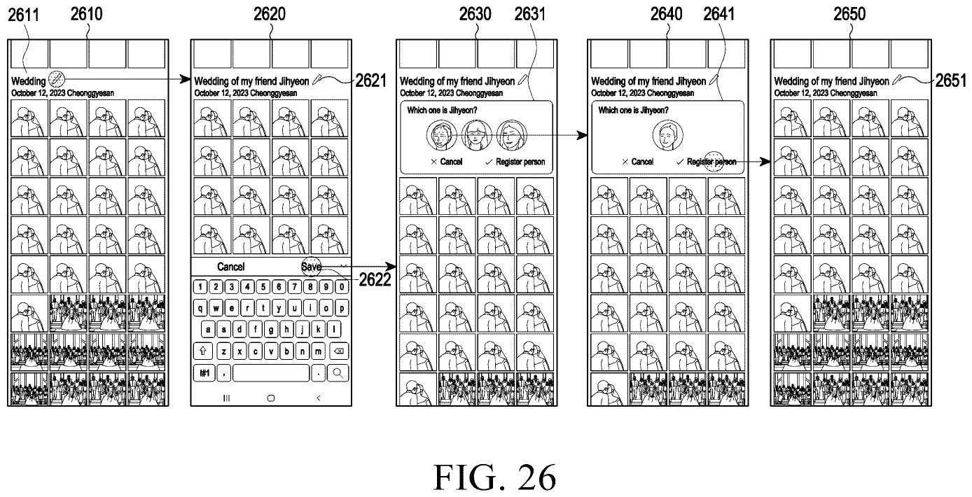

FIG. 26 is a view illustrating a method for changing a caption and registering a person, according to an embodiment.

Referring to FIG. 26, the processor 240 may analyze images captured on a specific date among images stored in memory, detect an event, and display a caption (e.g., a wedding) meeting the event, as illustrated at reference numeral 2610. In an embodiment, the processor 240 may display an object 2611 capable of editing content of the caption together with the caption.

In an embodiment, when a function of editing content of the caption is activated by a user input and content of the caption is newly input by a user input, the processor 240 may display a screen including a keyboard for inputting changed content of the caption and a user interface 2622 for storing the changed content of the caption through the display 210, as illustrated at reference numeral 2620.

In an embodiment, when a function of storing the changed content of the caption is activated by a user input, the processor 240 may identify whether new person information is included in the changed content of the caption. When it is determined that new person information is included in the changed content of the caption, the processor 240 may display a user interface 2631 for identifying whether a predetermined/certain number of persons having a high exposure frequency among persons included in images captured on a specific date match the new person information included in the changed content of the caption, as illustrated at reference numeral 2630. In an embodiment, when one person is selected by a user input, the processor 240 may display a user interface 2641 for identifying whether to register the selected person as the new person information included in the changed content of the caption, as illustrated at reference numeral 2640. In an embodiment, when person information registration is finally selected by a user input, the processor 240 may display a screen including changed caption information 2651 and the corresponding images through the display 210, as illustrated at reference numeral 2650.

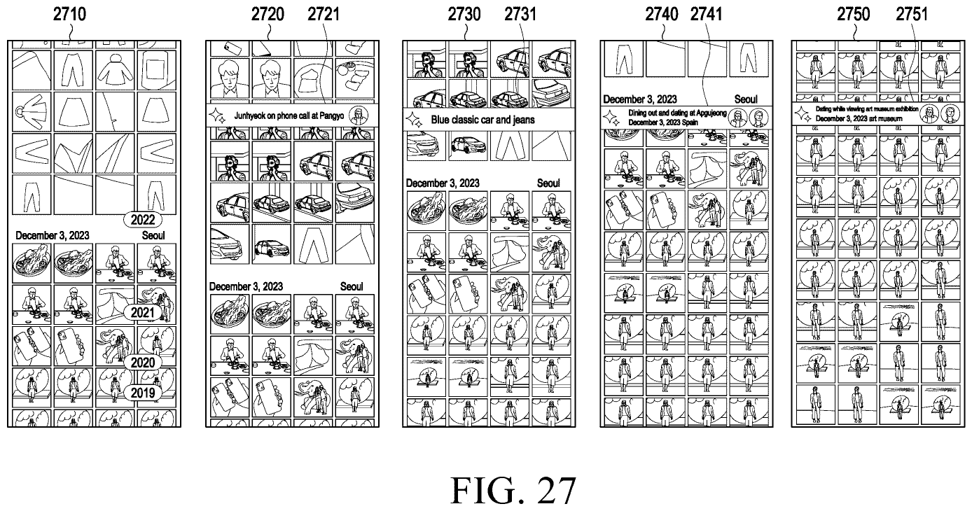

FIG. 27 is a view illustrating a method for displaying a caption describing an image, according to an embodiment.

Referring to FIG. 27, the processor 240 may display images stored in the memory 230 disposed in order of captured dates through the display 210, based on execution of an image application (e.g., a gallery application), as illustrated at reference numeral 2710.

In an embodiment, based on a user input for scrolling up the screen (e.g., a user input for scrolling the screen), the processor 240 may display a caption 2721 including person information included in images positioned in a specific area of the screen and information describing an action of the person or the like through the display 210 by analyzing the images, as illustrated at reference numeral 2720. In an embodiment, the processor 240 may display a thumbnail image representing person information included in the caption 2721 together with the caption 2721. For example, the person information and the thumbnail image included in the caption 2721 may be person information and a thumbnail image stored in an image application (e.g., a gallery application).

In an embodiment, based on a user input for scrolling up the screen (e.g., a user input for scrolling the screen), the processor 240 may display a caption 2731 including object information included in images positioned in a specific area of the screen and information describing the object through the display 210 by analyzing the images, as illustrated at reference numeral 2730.

In an embodiment, based on a user input for scrolling up the screen (e.g., a user input for scrolling the screen), the processor 240 may display captions 2741 and 2751 including person information and event information or the like included in images positioned in a specific area of the screen through the display 210 by analyzing the images, as illustrated at reference numerals 2740 and 2750. In an embodiment, the processor 240 may display a thumbnail image representing person information included in the caption 2731 together with the captions 2741 and 2751. For example, the person information and the thumbnail image included in the captions 2741 and 2751 may be person information and a thumbnail image stored in an image application (e.g., a gallery application). In an embodiment, when event information is included in the reference numeral caption 2731, the processor 240 may display a background color of the caption differently from a caption 2721 not including event information. In an embodiment, when event information is included in the reference numeral caption 2731, the processor 240 may additionally display additional information (e.g., a date, location information, etc. where images are captured) corresponding to the corresponding event in the caption 2731.

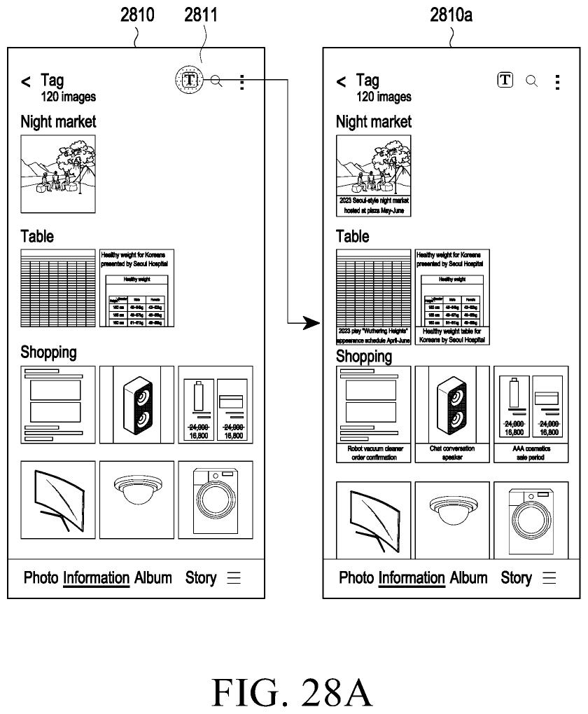

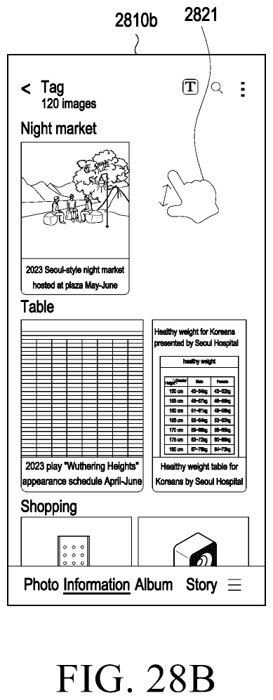

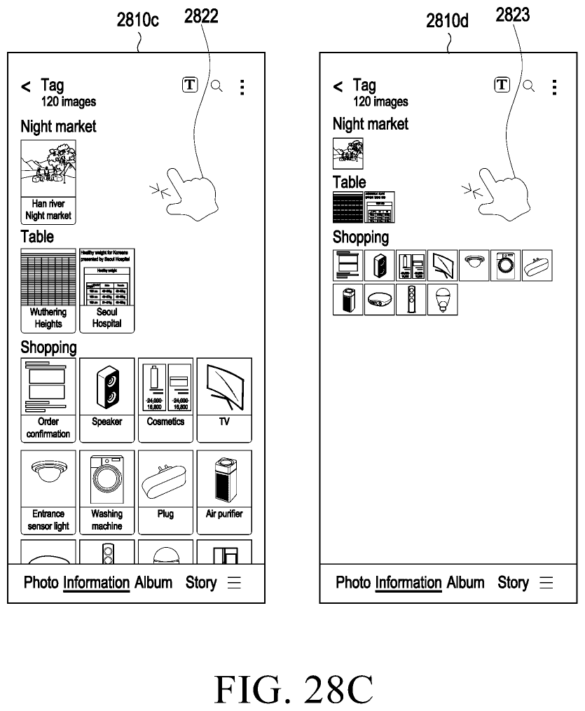

FIGS. 28A, 28B, and 28C are views illustrating a method for displaying a caption describing an image, according to an embodiment.

Referring to FIG. 28A, the processor 240 may group images including common information by category (e.g., night market, table, shopping) among images stored in the memory 230, and display the images through the display 210, when execution of an image application (e.g., a gallery application) and an information tab is selected, as illustrated at reference numeral 2810. In an embodiment, the processor 240 may display an object 2811 for displaying additional information for each of the images as text through the display 210.

In an embodiment, when the object 2811 is selected by a user input, the processor 240 may display an image summary keyword representing additional information for each of the images, as illustrated at reference numeral 2810a. In an embodiment, the processor 240 may analyze images and generate an image summary keyword using technologies such as visual question answering (VQA), optical character recognition (OCR), or the like. A user may quickly and easily identify what information each of the images represents through additional information for each of the images, without enlarging each of the images.

In an embodiment, the processor 240 may generate different image summary keywords based on a user input corresponding to a pinch in operation or pinch out operation.

Referring to reference numeral 2810b of FIG. 28B, the processor 240 may enlarge and display the images based on a user input 2821 corresponding to a pinch out operation, and may generate an image summary keyword including more information than the image summary keyword indicated by reference numeral 2810a, and display the image summary keyword together with each of the images.

Referring to reference numeral 2810c of FIG. 28C, the processor 240 may reduce and display the images based on a user input 2822 corresponding to a pinch in operation, and may generate an image summary keyword including less information than the image summary keyword indicated by reference numeral 2810a, and display the image summary keyword together with each of the images. Referring to reference numeral 2810d of FIG. 28C, the processor 240 may further reduce and display the images based on an additional user input 2823 corresponding to a pinch in operation, and may generate an image summary keyword including less information than the image summary keyword indicated by reference numeral 2810c and may display the image summary keyword together with each of the images.

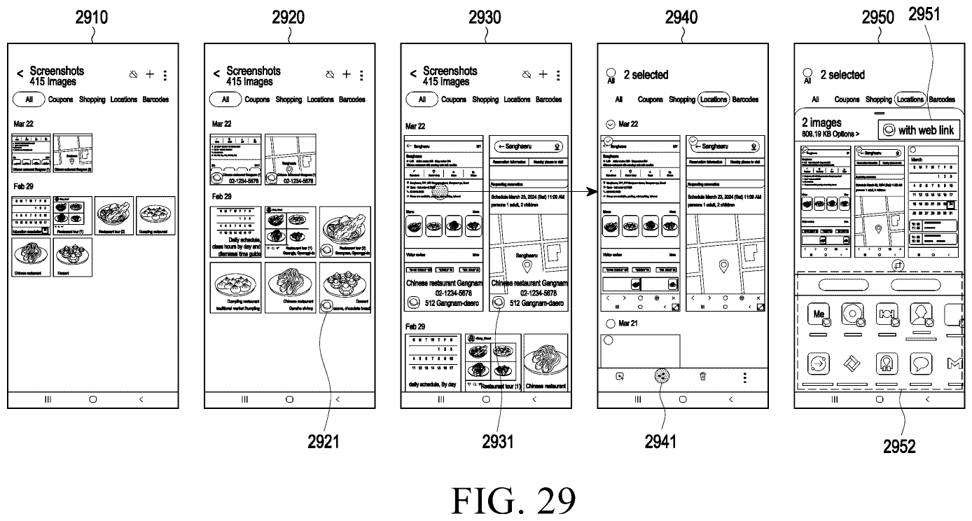

FIG. 29 is a view illustrating a method for providing an image summary keyword for a screenshot image, according to an embodiment.

Referring to FIG. 29, the processor 240 may display images stored in the memory 230 through the display 210, based on execution of an image application (e.g., a gallery application). In an embodiment, the processor 240 may display screenshot images among images stored in the memory 230 through the display 210, based on a user input selecting a screenshot album, as illustrated at reference numeral 2910. In an embodiment, the processor 240 may display an image summary keyword representing additional information for each of the images.

In an embodiment, the processor 240 may generate different image summary keywords based on a user input corresponding to a pinch out operation.

In an embodiment, the processor 240 may enlarge and display the images based on a user input corresponding to a pinch out operation, as illustrated at reference numeral 2920 of FIG. 29, and may generate an image summary keyword including more information than the image summary keyword indicated by reference numeral 2910 and display the image summary keyword together with each of the images. In an embodiment, the processor 240 may display an Internet connection icon 2921 for connecting to an Internet site on which the corresponding screenshot image is generated based on meta information of the corresponding screenshot image, together with the corresponding screenshot image, in a case of a screenshot image of an Internet screen.

In an embodiment, the processor 240 may enlarge and display the images to a size greater than that indicated by reference numeral 2910 based on an additional user input corresponding to a pinch out operation, as illustrated at reference numeral 2920 of FIG. 29, and may generate an image summary keyword including more information than the image summary keyword indicated by reference numeral 2920 and display the image summary keyword together with each of the images. In an embodiment, the processor 240 may display an Internet connection icon 2931 for connecting to an Internet site on which the corresponding screenshot image is generated based on meta information of the corresponding screenshot image, together with the corresponding screenshot image, in a case of a screenshot image of an Internet screen.

In an embodiment, based on a user input selecting a specific screenshot image, the processor 240 may display a user interface 2941 for executing a function of sharing the selected screenshot image together with the selected screenshot image through the display 210, as illustrated at reference numeral 2940 of FIG. 29.

In an embodiment, based on a user input for sharing the selected screenshot image, the processor 240 may display a user interface 2952 for sharing the selected screenshot image through the display 210, as illustrated at reference numeral 2950 of FIG. 29. In an embodiment, the processor 240 may display an icon 2951 for sharing an Internet link related to the selected screenshot image together through the display 210. In an embodiment, the processor 240 may share the selected screenshot image together with an Internet link related to the selected screenshot image, based on a user input for sharing the selected screenshot image together with an Internet link related to the selected screenshot image.

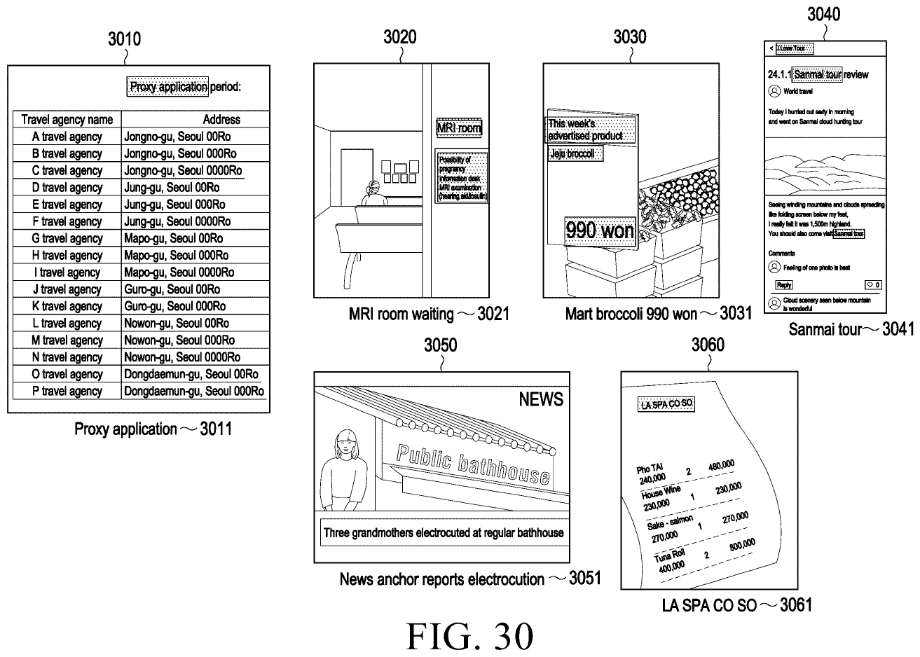

FIG. 30 is a view illustrating a method for analyzing images and generating an image summary keyword at least one of VQA or OCR, according to an embodiment.

In an embodiment, the processor 240 may analyze images and generate an image summary keyword using an OCR method, or using an OCR method and a VQA method, or using only an image recognition method, and the method for generating an image summary keyword is not limited thereto.

In an embodiment, the processor 240 may extract a character included in the corresponding image using an OCR method and generate an image summary keyword 3011 based on the extracted character, as illustrated at reference numeral 3010. In an embodiment, the processor 240 may extract a character having a size larger than other characters or a repeated character using an OCR method, and may generate an image summary keyword based on the extracted character.

In an embodiment, the processor 240 may extract a character included in the corresponding image using an OCR method, recognize a subject and an action of the subject included in the corresponding image using a VQA method, and generate image summary keywords 3021, 3031, 3041, 3051, and 3061 based on the extracted character and the recognized subject and action of the subject, as illustrated at reference numerals 3020, 3030, 3040, 3050, and 3060. In an embodiment, the processor 240 may extract a character having a size larger than other characters or a repeated character using an OCR method.

In an embodiment, an electronic device 201 may include a memory 230 and at least one processor 240. The at least one processor 240 may obtain a first image. The at least one processor 240 may select one or more second images from among a plurality of images stored in the memory 230 based on at least one of a generation time of the first image or a generation location of the first image included in metadata of the first image. The at least one processor 240 may obtain a third image by changing a value of at least one attribute among values of a plurality of attributes of the first image based on a user input. The at least one processor 240 may obtain one or more fourth images by changing values of a plurality of attributes of each of the one or more second images based on the values of the plurality of attributes of the third image.

In an embodiment, the first image may be selected from among a plurality of images stored in the memory 230 based on a user input or may be obtained through a camera 220 of the electronic device 201.

In an embodiment, the at least one processor 240 may select, as the one or more second images, images obtained through a camera 220 of the electronic device 201 within a designated time range based on the generation time of the first image, from among the plurality of images.

In an embodiment, the at least one processor 240 may select, as the one or more second images, images obtained through a camera 220 of the electronic device 201 within a designated distance based on the generation location of the first image, from among the plurality of images.

In an embodiment, the at least one processor 240 may obtain the one or more fourth images by applying the values of the plurality of attributes of the third image to the one or more second images.

In an embodiment, the at least one processor 240 may select a plurality of fifth images from among the plurality of images stored in the memory 230 based on a user input. The at least one processor 240 may determine the representative image from among the plurality of fifth images based on values of attributes of each of the plurality of fifth images and a position of an object included in each of the plurality of fifth images. The at least one processor 240 may correct a plurality of sixth images based on the values of the attributes of the representative image.

In an embodiment, the electronic device 201 may further include a camera 220. The at least one processor 240 may obtain a seventh image through the camera 220. The at least one processor 240 may generate a filter related to the first image based on the first image being obtained based on a camera setting value different from a camera setting value set by default. The at least one processor 240 may select a plurality of eighth images from among the plurality of images stored in the memory 230. The at least one processor 240 may correct the plurality of eighth images using the generated filter. The camera setting value may include an exposure value, a shutter speed, an International Organization for Standardization (ISO) value, a white balance, and/or focus information.

In an embodiment, the plurality of attributes may include exposure, brightness, contrast, highlight, shadow, chroma, color temperature, tint, sharpness, and/or clarity.

In an embodiment, a method for providing an image in an electronic device 201 may include an operation of obtaining a first image. The method may include an operation of selecting one or more second images from among a plurality of images stored in the memory of the electronic device 201 based on at least one of a generation time of the first image or a generation location of the first image included in metadata of the first image. The method may include an operation of obtaining a third image by changing a value of at least one attribute among values of a plurality of attributes of the first image based on a user input. The method may include an operation of obtaining the one or more fourth images by changing values of a plurality of attributes of each of the one or more second images based on the values of the plurality of attributes of the third image.

In an embodiment, the first image may be selected from among a plurality of images stored in the memory 230 based on a user input or may be obtained through a camera 220 of the electronic device 201.

In an embodiment, selecting the one or more second images may include selecting, as the one or more second images, images obtained through a camera 220 of the electronic device 201 within a designated time range based on the generation time of the first image, from among the plurality of images.

In an embodiment, selecting the one or more second images may include selecting, as the one or more second images, images obtained through a camera 220 of the electronic device 201 within a designated distance based on the generation location of the first image, from among the plurality of images.

In an embodiment, obtaining the one or more fourth images may include obtaining the one or more fourth images by applying the values of the plurality of attributes of the third image to the one or more second images.

In an embodiment, the method may further include an operation of selecting a plurality of fifth images from among the plurality of images stored in the memory 230 based on a user input. The method may further include an operation of determining the representative image from among the plurality of fifth images based on values of attributes of each of the plurality of fifth images and a position of an object included in each of the plurality of fifth images. The method may further include an operation of correcting a plurality of sixth images based on the values of the attributes of the representative image.

In an embodiment, the method may further include an operation of generating a filter related to the first image based on the first image being obtained based on a camera setting value different from a camera setting value set by default. The method may further include an operation of selecting a plurality of eighth images from among the plurality of images stored in the memory 230. The method may further include an operation of correcting the plurality of eighth images using the generated filter. The camera setting value may include an exposure value, a shutter speed, an ISO value, a white balance, and/or focus information.

In an embodiment, an electronic device 201 may include a camera 220, a display 210, memory 230, and at least one processor 240. The at least one processor 240 may identify whether a condition for storing a second image to be obtained through the camera 220 in the raw file format is satisfied, based on a first image obtained through the camera 220. The at least one processor 240 may display guide information for storing the second image in the raw file format upon obtaining the second image through the display 210, based on identifying that the condition is satisfied. The at least one processor 240 may store the second image in the raw file format in the memory 230, based on obtaining the second image through the camera 220 after displaying the guide information.

In an embodiment, the at least one processor 240 may identify whether the condition is satisfied based on contrast of the first image, brightness of the first image, noise of the first image, and/or whether a mode for capturing the first image is a portrait capture mode or a night capture mode.

In an embodiment, the at least one processor 240 may display an object for activating a mode for storing the second image in the raw file format together with the guide information through the display 210.

In an embodiment, the at least one processor 240 may sequentially obtain a third image and a fourth image through the camera 220. The at least one processor 240 may identify whether a similarity between the third image and the fourth image is equal to or greater than a threshold similarity. The at least one processor 240 may identify whether the condition is satisfied, based on the similarity between the third image and the fourth image being equal to or greater than the threshold similarity.

In an embodiment, the at least one processor 240 may correct the second image stored in the raw file format based on a user input.

Further, the structure of the data used in embodiments of the disclosure may be recorded in a computer-readable recording medium via various means. The computer-readable recording medium includes a storage medium, such as a magnetic storage medium (e.g., a ROM, a floppy disc, or a hard disc) or an optical reading medium (e.g., a CD-ROM or a DVD).

What is claimed is:

1. An electronic device, comprising:
memory storing instructions; and
at least one processor operably coupled to the memory,
wherein the instructions, when executed by the at least one processor individually or collectively, cause the electronic device to:
obtain a first image;
select one or more second images from among a plurality of images stored in the memory based on at least one of a generation time of the first image or a generation location of the first image in metadata of the first image;
obtain a third image by changing a value of at least one attribute among values of a plurality of attributes of the first image based on a user input; and
obtain one or more fourth images by changing values of a plurality of attributes of each of the one or more second images based on values of a plurality of attributes of the third image.

2. The electronic device of claim 1, wherein the first image is selected from among the plurality of images stored in the memory based on the user input or is obtained through a camera of the electronic device.

3. The electronic device of claim 1, wherein the instructions, when executed by the at least one processor individually or collectively, cause the electronic device to select, as the one or more second images, images obtained through a camera of the electronic device within a designated time range based on the generation time of the first image, from among the plurality of images.

4. The electronic device of claim 1, wherein the instructions, when executed by the at least one processor individually or collectively, cause the electronic device to select, as the one or more second images, images obtained through a camera of the electronic device within a designated distance based on the generation location of the first image, from among the plurality of images.

5. The electronic device of claim 1, wherein the instructions, when executed by the at least one processor individually or collectively, cause the electronic device to obtain the one or more fourth images by applying the values of the plurality of attributes of the third image to the one or more second images.

6. The electronic device of claim 5, wherein the instructions, when executed by the at least one processor individually or collectively, cause the electronic device to:
select a plurality of fifth images from among the plurality of images stored in the memory based on the user input;
determine a representative image from among the plurality of fifth images based on values of attributes of each of the plurality of fifth images and a position of an object in each of the plurality of fifth images; and
correct a plurality of sixth images based on values of attributes of the representative image.

7. The electronic device of claim 1, further comprising:
a camera,
wherein the instructions, when executed by the at least one processor individually or collectively, cause the electronic device to:
obtain a seventh image through the camera;
generate a filter related to the first image based on the first image being obtained based on a camera setting value different from a default camera setting value;
select a plurality of eighth images from among the plurality of images stored in the memory; and
correct the plurality of eighth images using the generated filter, and
wherein the camera setting value comprises an exposure value, a shutter speed, an international organization for standardization (ISO) value, a white balance, or focus information.

8. The electronic device of claim 1, wherein the plurality of attributes comprises exposure, brightness, contrast, highlight, shadow, chroma, color temperature, tint, sharpness, or clarity.

9. A method for providing an image in an electronic device, the method comprising:
obtaining a first image;
selecting one or more second images from among a plurality of images stored in a memory of the electronic device based on at least one of a generation time of the first image or a generation location of the first image in metadata of the first image;
obtaining a third image by changing a value of at least one attribute among values of a plurality of attributes of the first image based on a user input; and
obtaining one or more fourth images by changing values of a plurality of attributes of each of the one or more second images based on values of a plurality of attributes of the third image.

10. The method of claim 9, wherein the first image is selected from among the plurality of images stored in the memory based on the user input or is obtained through a camera of the electronic device.

11. The method of claim 9, wherein selecting the one or more second images comprises selecting, as the one or more second images, images obtained through a camera of the electronic device within a designated time range based on the generation time of the first image, from among the plurality of images.

12. The method of claim 9, wherein selecting the one or more second images comprises selecting, as the one or more second images, images obtained through a camera of the electronic device within a designated distance based on the generation location of the first image, from among the plurality of images.

13. The method of claim 9, wherein obtaining the one or more fourth images comprises obtaining one or more fourth images by applying the values of the plurality of attributes of the third image to the one or more second images.

14. The method of claim 13, further comprising:
selecting a plurality of fifth images from among the plurality of images stored in the memory based on the user input;
determining a representative image from among the plurality of fifth images based on values of attributes of each of the plurality of fifth images and a position of an object in each of the plurality of fifth images; and
correcting a plurality of sixth images based on values of attributes of the representative image.

15. The method of claim 9, further comprising:
obtaining a seventh image through a camera of the electronic device;
generating a filter related to the first image based on the first image being obtained based on a camera setting value different from a camera setting value set by default;
selecting a plurality of eighth images from among the plurality of images stored in the memory; and
correcting the plurality of eighth images using the generated filter,
wherein the camera setting value comprises an exposure value, a shutter speed, an international organization for standardization (ISO) value, a white balance, or focus information.

16. The method of claim 9, wherein the plurality of attributes comprises exposure, brightness, contrast, highlight, shadow, chroma, color temperature, tint, sharpness, or clarity.

17. A non-transitory computer-readable medium storing computer-executable instructions, the computer-executable instructions that, when executed by at least one processor, cause an electronic device to perform operations, the operations comprising:
obtaining a first image;
selecting one or more second images from among a plurality of images stored in a memory of the electronic device based on at least one of a generation time of the first image or a generation location of the first image in metadata of the first image;
obtaining a third image by changing a value of at least one attribute among values of a plurality of attributes of the first image based on a user input; and
obtaining one or more fourth images by changing values of a plurality of attributes of each of the one or more second images based on values of a plurality of attributes of the third image.

18. The non-transitory computer-readable medium of claim 17, wherein the first image is selected from among the plurality of images stored in the memory based on the user input or is obtained through a camera of the electronic device.

19. The non-transitory computer-readable medium of claim 17, wherein selecting the one or more second images comprises selecting, as the one or more second images, images obtained through a camera of the electronic device within a designated time range based on the generation time of the first image, from among the plurality of images.

20. The non-transitory computer-readable medium of claim 17, wherein selecting the one or more second images comprises selecting, as the one or more second images, images obtained through a camera of the electronic device within a designated distance based on the generation location of the first image, from among the plurality of images.
